(19) United States
(12) Patent Application Publication
(10) Pub. No.: US 2014/0052377 A1
(43) Pub. Date: Feb. 20, 2014

(54) SYSTEM AND METHOD FOR PERFORMING RESERVOIR STIMULATION OPERATIONS

(71) Applicant: Schlumberger Technology Corporation, Sugar Land, TX (US)

(72) Inventor: Robert Downie, Edmond, OK (US)

(73) Assignee: Schlumberger Technology Corporation, Sugar Land, TX (US)

(21) Appl. No.: 13/968,648

(22) Filed: Aug. 16, 2013

Related U.S. Application Data
(60) Provisional application No. 61/684,588, filed on Aug. 17, 2012.

(51) Int. Cl. G01V 1/40

(52) U.S. Cl. CPC G01V 1/40
USPC 702/11

(57) ABSTRACT

A computer system and method for monitoring at least one performance aspect of a plurality of well stimulation operations conducted on a production well penetrating a subterranean formation. The computer system and method involves calculating seismic moments of the microseismic events based upon the shear and compressional waves of the microseismic signal data, totalizing the seismic moment values to a form a cumulative moment of the microseismic events occurring during the time period, and normalizing the seismic moments with the cumulative moment to transform the seismic moments into a normalized seismic moment data set. The microseismic signal data is indicative of shear and compressional waves having amplitudes and frequencies of microseismic events induced by the plurality of well stimulation operations over different time periods.

### CROSS-REFERENCE TO RELATED APPLICATION

This application claims the benefit of priority to related U.S. Provisional Application Ser. No. 61/684,588 filed 17 Aug. 2012, entitled “SYSTEM AND METHOD FOR PERFORMING RESERVOIR STIMULATION OPERATIONS,” the disclosure of which is incorporated by reference herein in its entirety.

### BACKGROUND

Understanding the nature and degree of hydraulic fracture complexity may be useful to the economic development of unconventional resources. Examples of hydraulic fracture techniques are described in the following papers: Mayerhofer et al., Integrating of Microseismic Fracture Mapping Results with Numerical Fracture Network Production Modeling in the Barnett Shale, Society of Petroleum Engineers (SPE) 102103, presented at the SPE Annual Technical Conference and Exhibition, San Antonio, Tex., 24-24 Sep. 2006; Mayerhofer et al., What is Stimulated Reservoir Volume (SRV)?, SPE 119890 presented at the SPE Shale Gas Production Conference, Fort Worth, Tex., 16-18 Nov. 2008; Warpinski et al., Stimulating Unconventional Reservoirs Maximizing Network Growth while Optimizing Fracture Conductivity, SPE 114173 presented at the SPE Unconventional Reservoirs Conference, Keystone, Colo., 10-12 Feb. 2008; and Cipolla et al., The Relationship between Fracture Complexity, Reservoir Properties, and Fracture Treatment Design, SPE 115769 presented at the SPE Annual Technical Conference and Exhibition, Denver, Colo., 21-24 Sep. 2008.

Complex hydraulic fracture propagation may be interpreted from microseismic measurements, for example, from unconventional reservoirs and tight gas reservoirs. Examples of complex hydraulic fracture techniques are provided in the following articles: Maxwell et al., Microseismic Imaging of Hydraulic Fracture Complexity in the Barnett Shale, SPE 77440 presented at the SPE Annual Technical Conference and Exhibition, San Antonio, Tex., Sep. 29-Oct. 2, 2002; Fisher et al., Integrating Fracture Mapping Technologies to Optimize Stimulations in the Barnett Shale, 77411 presented at the SPE Annual Technical Conference and Exhibition, San Antonio, Tex., Sep. 29-Oct. 2, 2002; Cipolla et al., Effect of Well Placement on Production and Frac Design in a Mature Tight Gas Field, 95337 presented at the SPE Annual Technical Conference and Exhibition, Dallas, Tex., 9-12 Oct. 2005; and Warpinski et al., Stimulating Unconventional Reservoirs: Maximizing Network Growth while Optimizing Fracture Conductivity, SPE 114173 presented at the SPE Unconventional Reservoirs Conference, Keystone, Colo., 10-12 Feb. 2008.

Seismic monitoring is known as a method with an observation horizon that penetrates far deeper into a hydrocarbon reservoir than any other method employed in the oilfield industry. It has been proposed to exploit the reach of seismic methods for the purpose of reservoir monitoring.

In conventional seismic monitoring a seismic source, such as airguns, vibrators or explosives are activated and generate sufficient acoustic energy to penetrate the earth. Reflected or refracted parts of this energy are then recorded by seismic receivers such as hydrophones and geophones.

In microseismic monitoring the seismic energy is generated through so-called local microseismic events either naturally occurring in the formation or caused by human activity or intervention. The events include seismic events caused by fracturing operations to be described in more detail below, by very small sources injected for example with wellbore fluids, or background events illuminating the area of interest. Those variants of the microseismic methods which lack an actively controlled seismic source are sometimes also referred to as passive seismic monitoring. For the purpose of the present invention, microseismic shall include all of the above described variants.

Referring now in more detail to hydraulic fracturing operations, it is known that production or storage capacity of underground reservoirs can be improved using a procedure known as hydraulic fracturing. Hydraulic fracturing operations are for example commonly performed in formations where oil or gas cannot be easily or economically extracted from the earth from drilled and perforated wellbores alone.

These operations include the steps of pumping through a borehole large amounts of fluid to induce cracks in the earth, thereby creating pathways via which the oil and gas can flow more readily than prior to the fracturing. After a crack is generated, sand or some other proppant material is commonly injected into the crack, such that a crack is kept open even after release of the applied pressure. The particulate proppant provides a conductive pathway for the oil and gas to flow through the newly formed fracture into the main wellbore.

The hydraulic fracturing processes cannot be readily observed, since they are typically thousands of feet or meters below the surface of the earth. Therefore, members of the oil and gas industry have sought diagnostic methods to tell where the fractures are, how big the fractures are, how far they go and how high they grow. As mentioned above, one method of observing fracturing operations has been found in the use of microseismic monitoring.

Understanding the nature and degree of hydraulic fracture complexity may be useful to the economic development of unconventional resources. Examples of hydraulic fracture techniques are described in the following papers: Mayerhofer et al., Integrating of Microseismic Fracture Mapping Results with Numerical Fracture Network Production Modeling in the Barnett Shale, Society of Petroleum Engineers (SPE) 102103, presented at the SPE Annual Technical Conference and Exhibition, San Antonio, Tex., 24-24 Sep. 2006; Mayerhofer et al., What is Stimulated Reservoir Volume (SRV)?, SPE 119890 presented at the SPE Shale Gas Production Conference, Fort Worth, Tex., 16-18 Nov. 2008; Warpinski et al., Stimulating Unconventional Reservoirs Maximizing Network Growth while Optimizing Fracture Conductivity, SPE 114173 presented at the SPE Unconventional Reservoirs Conference, Keystone, Colo., 10-12 Feb. 2008; and Cipolla et al., The Relationship between Fracture Complexity, Reservoir Properties, and Fracture Treatment Design, SPE 115769 presented at the SPE Annual Technical Conference and Exhibition, Denver, Colo., 21-24 Sep. 2008.

Complex hydraulic fracture propagation may be interpreted from microseismic measurements, for example, from unconventional reservoirs and tight gas reservoirs. Examples of complex hydraulic fracture techniques are provided in the following articles: Maxwell et al., Microseismic Imaging of Hydraulic Fracture Complexity in the Barnett Shale, SPE 77440 presented at the SPE Annual Technical Conference and Exhibition, San Antonio, Tex., Sep. 29-Oct. 2, 2002; Fisher et al., Integrating Fracture Mapping Technologies to Optimize Stimulations in the Barnett Shale, 77411 presented at the SPE Annual Technical Conference and Exhibition, San Antonio, Tex., Sep. 29-Oct. 2, 2002; Cipolla et al., Effect of Well Placement on Production and Frac Design in a Mature Tight Gas Field, 95337 presented at the SPE Annual Technical Conference and Exhibition, Dallas, Tex., 9-12 Oct. 2005; and Warpinski et al., Stimulating Unconventional Reservoirs: Maximizing Network Growth while Optimizing Fracture Conductivity, SPE 114173 presented at the SPE Unconventional Reservoirs Conference, Keystone, Colo., 10-12 Feb. 2008.

In some cases, challenges may exist in distinguishing between small scale fracture complexity and simple planar fracture growth. A factor that may influence the creation of complex fracture systems is the presence and distribution of natural fractures. An example of complex fractures is shown in Cipolla et al., Integrating Microseismic Mapping and Complex Fracture Modeling to Characterize Fracture Complexity, SPE 140185 presented at the SPE Hydraulic Fracturing Technology Conference, The Woodlands, Tex., 24-26 Feb. 2011. Discrete Fracture Network (DFN) models have been used to simulate production in naturally fractured reservoirs as shown, for example, in the following papers: Dershowitz et al., A Workflow for Integrated Barnett Shale Reservoir Modeling and Simulation, SPE 122934 presented at the SPE Latin American and Caribbean Petroleum Engineering Conference, Cartagena, Columbia, 31 May-3 Jun. 2009; Quiet al., Applying Curvature and Fracture Analysis to the Placement of Horizontal Wells: Example from the Mabee (San Adres) Reservoir, Tex., SPE 70010 presented at the SPE Permian Basin Oil and Gas Recovery Conference, Midland, Tex. 15-17 May 2001; and Will et al., Integration of Seismic Anisotropy and Reservoir-Performance Data for Characterization of Naturally Fractured Reservoirs Using Discrete-Feature-Network Models, SPE 84412 presented at the SPE Annual Technical Conference and Exhibition, Denver, Colo., 5-8 Oct. 2003. These methods, along with log-based approaches (see, e.g., Bratton et al., Rock Strength Parameters from Annular Pressure While Drilling and Dipole Sonic Dispersion Analysis, Presented at the SPWLA 45th Annual Logging Symposium, Noordwijk, The Netherlands, 6-9 Jun. 2004) may be primarily descriptive. Some such methods may be used to characterize a structure of the natural fracture network by using seismic information to extend observations at the wellbore across the reservoir.

Some models have also been developed to quantify the propagation of complex hydraulic fracture networks in, for example, formations embedded with predefined, deterministic or stochastic natural fractures. Examples of complex fracture models are described in the following: Sahimi, M., New Models For Natural And Hydraulic Fracturing On Heterogeneous Rock, SPE 29648 presented at the SPE Western Regional Meeting, Bakersfield, Calif. (1995); Fomin et al., Advances In Mathematical Modeling Of Hydraulic Stimulation Of A Subterranean Fractured Reservoir, Proc. SPIE 5831: 148-154 (2005); Napier et al., Comparison Of Numerical And Physical Models For Understanding Shear Fracture Process, Pure Appl. Geophys, 163: 1153-1174 (2006); Tezuka et al., Fractured Reservoir Characterization Incorporating Microseismic Monitoring And Pressure Analysis During Massive Hydraulic Injection, IPTC 12391 presented at the International Petroleum Technology Conference, Kuala Lumpur, Malaysia (2008); Olsen et al., Modeling Simultaneous Growth Of Multiple Hydraulic Fractures And Their Interaction With Natural Fractures, SPE 119739 presented at the Hydraulic Fracturing Technology Conference, The Woodlands, Tex. (2009); and Xu et al., Characterization of Hydraulically Induced Shale Fracture Network Using an Analytical/Semi-Analytical Model, SPE 124697 presented at the SPE Annual Technical Conference and Exhibition, New Orleans, 4-7 Oct. 2009; and Weng et al., Modeling of Hydraulic Fracture Propagation in a Naturally Fractured Formation, SPE 140253 presented at the SPE Hydraulic Fracturing Technology Conference, Woodlands, Tex., USA, 24-26 Jan. 2011. In some models, microseismic activity may be used to constrain the fracturing process.

Moment values are used for comparison of the relative intensity of the microseismic source mechanisms that result in event detections. Moment is usually converted to moment-magnitude for these comparisons although some publications have used the moment derived from the amplitudes of the detected waveforms. Various patents and patent applications are published on seismic/microseismic monitoring discussing moment or cumulative moment values, such as: US20120160481A1, US20090048783A1, and US20050060099A1. Cumulative moment has been mentioned in publications, mostly with relation to seismological studies. For example: Urbancic et al., Long-term Assessment of Reservoir Integrity Utilizing Seismic Source Parameters As Recorded With Integrated Microseismic-pressure Arrays, 2011 SEG Annual Meeting, Sep. 18-23, 2011, San Antonio, Tex.; Downie et al., Using Microseismic Source Parameters To Evaluate the Influence of Faults on Fracture Treatments: A Geophysical Approach to Interpretation, SPE Annual Technical Conference and Exhibition, 19-22 Sep. 2010, Florence, Italy; Cipolla et al., Engineering Guide to the Application of Microseismic Interpretations, SPE Hydraulic Fracturing Technology Conference, 6-8 Feb. 2012, The Woodlands, Tex., USA; Neuhaus et al., Analysis of Surface and Downhole Microseismic Monitoring Coupled with Hydraulic Fracture Modeling in the Woodford Shale, SPE Europec/EAGE Annual Conference, 4-7 Jun. 2012, Copenhagen, Denmark; N. R. Warpinski, Integrating Microseismic Monitoring With Well Completions, Reservoir Behavior, and Rock Mechanics, SPE Tight Gas Completions Conference, 15-17 Jun. 2009, San Antonio, Tex., USA; Prince et al., Identifying Stress Transfer in CSS Reservoir Operations Through Integrated Microseismic Solutions, SPE Middle East Oil and Gas Show and Conference, 25-28 Sep. 2011, Manama, Bahrain; Maxwell et al., What Does Microseismicity Tell Us About Hydraulic Fracturing?, SPE Annual Technical Conference and Exhibition, 30 Oct.-2 Nov. 2011, Denver, Colo., USA; Maxwell et al., Microseismic Deformation Rate Monitoring, SPE Annual Technical Conference and Exhibition, 21-24 Sep. 2008, Denver, Colo., USA; Maxwell et al., Seismic Velocity Model Calibration Using Dual Monitoring Well Data, SPE Hydraulic Fracturing Technology Conference, 19-21 Jan. 2009, The Woodlands, Tex.; Maxwell et al., Monitoring Steam Injection Deformation Using Microseismicity and Tiltmeters, The 42nd U.S. Rock Mechanics Symposium (USRMS), June 29-Jul. 2, 2008, San Francisco, Calif.; Maxwell et al., Monitoring SAGD Steam Injection Using Microseismicity and Tiltmeters, SPE Annual Technical Conference and Exhibition, 11A4 Nov. 2007, Anaheim, Calif., U.S.A.; Maxwell et al., Monitoring SAGD Steam Injection Using Microseismicity and Tiltmeters, SPE Reservoir Evaluation & Engineering, Volume 12, Number 2, April 2009; Osorio et al., Correlation Between Microseismicity and Reservoir Dynamics in a Tectonically Active Area of Colombia, SPE Annual Technical Conference and Exhibition, 21-24 Sep. 2008, Denver, Colo., USA; and, Sweby et al., High Resolution Seismic Monitoring at Mt Keith Open Pit Mine, Golden Rocks 2006, The 41st U.S. Symposium on Rock Mechanics (USRMS), Jun. 17-21, 2006, Golden, Colo.

Microseismic moment is a measurement that is related to the deformation that occurs within rocks during the process of hydraulic fracturing. It is this deformation that produces the shear and compressional waves that are detected as microseismic events. The moment values for each event vary with the area of the failure, the displacement that occurs as a result of the slip, and the shear modulus of the rock. Moment values are normally converted to a magnitude value that is consistent with the seismic magnitude scale.

The microseismic moment is a measurement that is based on the amplitudes of the shear and/or compressional waves that are detected during hydraulic fracturing monitoring projects. The moment value is directly proportional to the deformation if the mechanical properties of the rock are constant. This deformation consists of a slip area, and displacement. One assumption which may be made by the present disclosure hereof, is that the properties of the reservoir rocks that influence the observed moment do not change appreciably, and therefore the microseismic moment values can be used to evaluate the location, time, and relative size of the deformations that occur during hydraulic fracturing treatments.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one embodiment, the present disclosure describes a method of performing a well stimulation operation for a wellsite having a subterranean formation. In this method, a plurality of data acquisition tools are positioned proximate to the subterranean formation. A well stimulation operation on a production well penetrating the subterranean formation is conducted, and microseismic signals are detected by the plurality of data acquisition tools. The microseismic signals include shear and compressional waves, the shear and compressional waves having amplitudes and frequencies indicative of microseismic events induced by the well stimulation operation over a time period from T1 to T2. One or more processor calculates seismic moments of the microseismic events based upon the shear and compressional waves received by the plurality of data acquisition tools. The seismic moment values are totalized the processor to a form a cumulative moment of the microseismic events occurring during the time period. Then, the processor normalizes the seismic moment values with the cumulative moment to transform the seismic moments into a normalized seismic moment data set. In another embodiment, the present disclosure describes a method of monitoring at least one performance aspect of a plurality of well stimulation operations conducted on a production well penetrating a subterranean formation. In this embodiment, microseismic signals including shear and compressional waves are detected by a plurality of data acquisition tools positioned proximate to the production well. The shear and compressional waves have amplitudes and frequencies indicative of microseismic events induced by the plurality of well stimulation operations over different time periods. For each well stimulation operation, a processor calculates seismic moments of the microseismic events based upon the shear and compressional waves received by the plurality of data acquisition tools; totalizes the seismic moment values to a form a cumulative moment of the microseismic events occurring during the time period; and normalizes the seismic moments with the cumulative moment to transform the seismic moments into a normalized seismic moment data set.

In yet another embodiment, the present disclosure describes a computer system for monitoring at least one performance aspect of a plurality of well stimulation operations conducted on a production well penetrating a subterranean formation. The computer system is provided with at least one processor; and at least one computer readable medium coupled to the at least one processor. The at least one computer readable medium stores microseismic signal data indicative of shear and compressional waves having amplitudes and frequencies of microseismic events induced by the plurality of well stimulation operations conducted over different time periods. The at least one computer readable medium also stores a well analysis program including computer executable instructions executed by the at least one processor for each well stimulation operation to: calculate seismic moments of the microseismic events based upon the shear and compressional waves of the microseismic signal data; totalize the seismic moment values to a form a cumulative moment of the microseismic events; and normalize the seismic moments with the cumulative moment of the microseismic events to transform the seismic moments into a normalized seismic moment data set.

Embodiments of the present disclosure may include one or more method, computing device, computer-readable medium, and system for microseismic fracture network (MFN) modeling.

### BRIEF DESCRIPTION OF THE DRAWINGS

Embodiments of microseismic fracture techniques are described with reference to the following Figures. The same numbers are used throughout the Figures to reference like features and components. Implementations of various technologies will hereafter be described with reference to the accompanying drawings. It should be understood, however, that the accompanying drawings illustrate only the various implementations described herein and are not meant to limit the scope of various technologies described herein.

FIGS. 1A-1E illustrate simplified, schematic views of an oilfield having subterranean formations containing reservoirs therein in accordance with implementations of various technologies and techniques described herein; in particular:

FIG. 1A illustrates a survey operation being performed by a survey tool, such as seismic truck 106.1, to measure properties of the subterranean formation.

FIG. 1B illustrates a drilling operation being performed by a drilling tool suspended by a rig and advanced into the subterranean formation to form a wellbore.

FIG. 1C illustrates a wireline operation being performed by a wireline tool suspended by the rig and into the wellbore of FIG. 1B.

FIG. 1D illustrates a production operation being performed by a production tool deployed from a production unit or Christmas tree and into completed wellbore for drawing fluid from the downhole reservoirs into surface facilities.

FIG. 1E depicts an exemplary microseismic fracture operation system that can be used to perform the reservoir stimulation operations discussed herein.

FIG. 2 illustrates a schematic view, partially in cross section, of an oilfield having a plurality of data acquisition tools positioned at various locations along the oilfield for collecting data from the subterranean formations in accordance with implementations of various technologies and techniques described herein.

FIG. 3 illustrates a production system for performing one or more oilfield operations in accordance with implementations of various technologies and techniques described herein.

FIG. 4 is a flow chart of a method in accordance with implementations of various technologies and techniques described herein.

FIG. 5 illustrates a graph showing a relationship of microseismic events detected versus distance between data acquisition tools and the microseismic events.

FIG. 6 illustrates a graph showing a relationship between a magnitude of a microseismic event and the microseismic event's moment.

FIG. 7 illustrates a partial perspective view of a rock fracturing into a first rock and a second rock in which the second rock moves relative to the first rock resulting in a microseismic event having a moment.

FIG. 8 illustrates a graph showing a cumulative moment plot over a time period in which the cumulative moment is a sum of individual moments of microseismic events.

FIG. 9 illustrates a graph showing individual microseismic moments occurring over a time period that have been normalized with the cumulative moment.

FIGS. 10A and 10B illustrate graphs showing variability in microseismic responses to the stimulation operation in which multiple sets of cumulative magnitudes of microseismic events are depicted over a time period.

FIGS. 11A and 11B illustrate graphs showing variability in microseismic responses to the stimulation operation in which multiple sets of cumulative moments of microseismic events are depicted over a time period.

FIG. 12 illustrates a graph depicting multiple sets of individual microseismic event moments that have been normalized as a percentage of cumulative moment versus depth of the individual microseismic events.

FIG. 13 illustrates a graph showing a three-dimensional location of individual microseismic events and a portion of a wellbore that has undergone a stimulation operation resulting in the microseismic events in accordance with implementations of various technologies and techniques described herein.

FIGS. 14A and 14B illustrate a three-dimensional model having mapped deformation based on fractional values of the cumulative moment and comparison to modeled fracture geometry.

FIG. 15 schematically illustrates a computer system in accordance with implementations of various technologies and techniques described herein.

FIG. 16 is an exemplary logic flow chart illustrating a computerized methodology for monitoring at least one performance aspect of a plurality of well stimulation operations conducted on the wellbore penetrating the subterranean formation.

### DETAILED DESCRIPTION

The discussion below is directed to certain specific implementations. It is to be understood that the discussion below is only for the purpose of enabling a person with ordinary skill in the art to make and use any subject matter defined now or later by the patent “claims” found in any issued patent herein.

Unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the inventive concept. This description should be read to include one or at least one and the singular also includes the plural unless otherwise stated.

The terminology and phraseology used herein is for descriptive purposes and should not be construed as limiting in scope. Language such as “including,” “comprising,” “having,” “containing,” or “involving,” and variations thereof, is intended to be broad and encompass the subject matter listed thereafter, equivalents, and additional subject matter not recited.

Finally, as used herein any references to “one embodiment” or “an embodiment” means that a particular element, feature, structure, or characteristic described in connection with the embodiment is included in at least one embodiment. The appearances of the phrase “in one embodiment” in various places in the specification are not necessarily referring to the same embodiment.

The disclosure relates to techniques for performing and evaluating reservoir stimulation operations, such as a fracturing operation and/or acidizing operation that are used to form a complex fracture network resulting in microseismic activity. The microseismic activity may be observed with data acquisition tools acquiring microseismic signals from the microseismic activity. The techniques disclosed herein may be used, for example, to permit a qualitative evaluation of microseismic responses observed during multiple stimulation operation method within a single wellbore or group of wellbores located within the same geological horizon; evaluation and comparison of observed deformations within rock strata while fracturing, for example, using a fractional value of a total microseismic moment using spatial dimensions such as depth or distance from a specified reference location; and mapping of the deformation in a geological model for use in fracture stimulation operation modeling. The techniques disclosed herein may not be restricted to a particular formation, well type, and/or type of array used to acquire the microseismic signal.

### Introduction

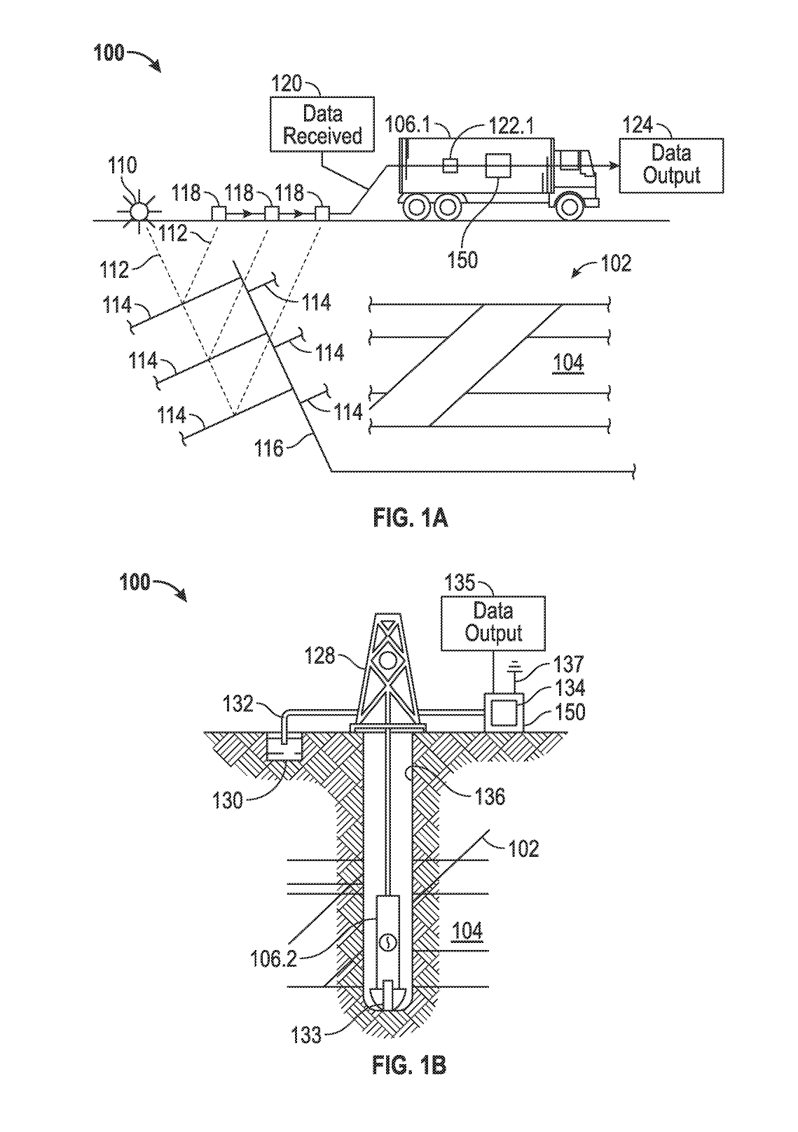

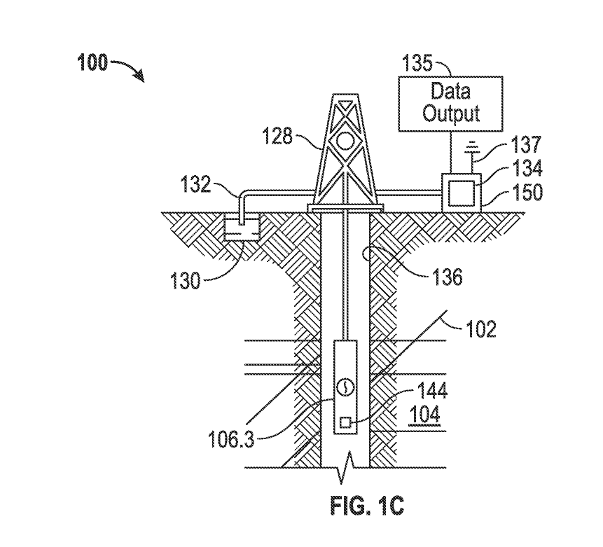

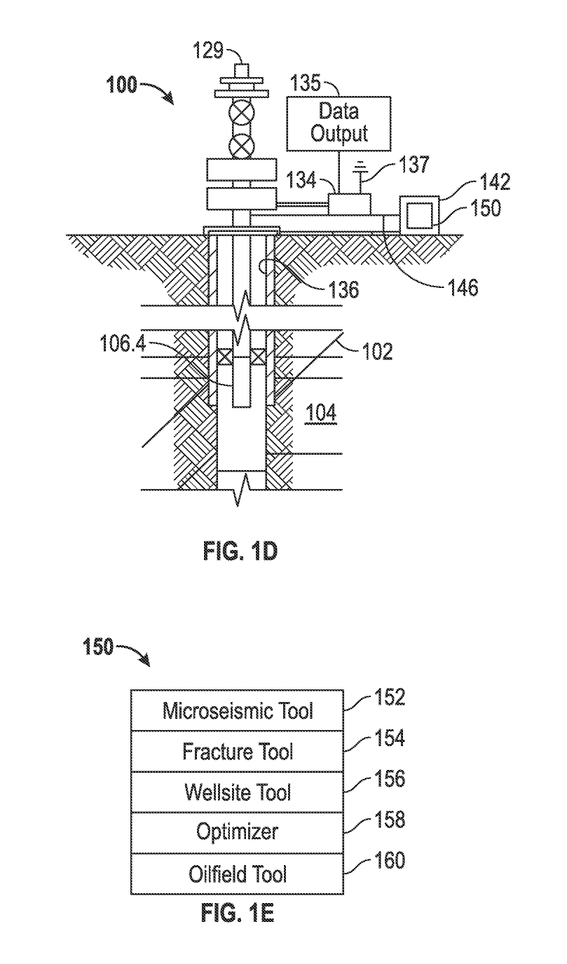

FIGS. 1A-1D illustrate simplified, schematic views of oilfield 100 having subterranean formation 102 containing reservoir 104 therein in accordance with implementations of various technologies and techniques described herein. FIG. 1A illustrates a survey operation being performed by a survey tool, such as seismic truck 106.1, to measure properties of the subterranean formation. The survey operation may be a seismic survey operation for producing sound vibrations, and/or a reservoir stimulation operation such as a fracturing operation. In FIG. 1A, a source 110 generates sound vibration 112 that reflects off horizons 114 in earth formation 116. A set of sound vibrations is received by sensors, such as geophone-receivers 118, situated on the earth's surface or within a monitoring well-bore (not shown in FIG. 1A). The data received 120 is provided as input data to a computer 122.1 of a seismic truck 106.1, and responsive to the input data, computer 122.1 generates seismic data output 124. This seismic data output may be stored, transmitted or further processed as desired, for example, by data reduction. When the survey operation is a reservoir stimulation operation, the oilfield 100 may also include a surface unit 134 (depicted in FIG. 1B) having a microseismic fracture operation system 150 as will be described further herein.

FIG. 1B illustrates a drilling operation being performed by drilling tools 106.2 suspended by rig 128 and advanced into subterranean formations 102 to form wellbore 136. The oilfield 100 may also include a mud pit 130 used to draw drilling mud into the drilling tools 106.2 via flow line 132 for circulating drilling mud down through the drilling tools 106.2, then up wellbore 136 and back to the surface. The drilling mud may be filtered and returned to the mud pit 130. A circulating system may be used for storing, controlling, or filtering the flowing drilling muds. The drilling tools 106.2 are advanced into subterranean formations 102 to reach reservoir 104. Each well may target one or more reservoirs 104. The drilling tools 106.2 are adapted for measuring downhole properties using logging while drilling tools. The logging while drilling tools may also be adapted for taking a core sample 133 as shown.

Computer facilities may be positioned at various locations about the oilfield 100 (e.g., the surface unit 134) and/or at remote locations. Surface unit 134 may be used to communicate with the drilling tools and/or offsite operations, as well as with other surface or downhole sensors. Surface unit 134 is capable of communicating with the drilling tools 106.2 to send commands to the drilling tools 106.2, and to receive data therefrom. Surface unit 134 may also collect data generated during the drilling operation and produce data output 135, which may then be stored or transmitted.

Sensors (S), such as gauges, may be positioned about oilfield 100 to collect data relating to various oilfield operations as described previously. As shown, sensor (S) is positioned in one or more locations in the drilling tools 106.2 and/or at rig 128 to measure drilling parameters, such as weight on bit, torque on bit, pressures, temperatures, flow rates, compositions, rotary speed, and/or other parameters of the field operation. Sensors (S) may also be positioned in one or more locations in the circulating system.

Drilling tools 106.2 may include a bottom hole assembly (BHA) (not shown) near the drill bit (e.g., within several drill collar lengths from the drill bit). The bottom hole assembly includes capabilities for measuring, processing, and storing information, as well as communicating with surface unit 134. The bottom hole assembly further includes drill collars for performing various other measurement functions.

The bottom hole assembly may include a communication subassembly that communicates with surface unit 134. The communication subassembly is adapted to send signals to and receive signals from the surface using a communications channel such as mud pulse telemetry, electro-magnetic telemetry, or wired drill pipe communications. The communication subassembly may include, for example, a transmitter that generates a signal, such as an acoustic or electromagnetic signal, which is representative of the measured drilling parameters. It will be appreciated by one of skill in the art that a variety of telemetry systems may be employed, such as wired drill pipe, electromagnetic or other known telemetry systems.

The wellbore may be drilled according to a drilling plan that is established prior to drilling. The drilling plan may set forth equipment, pressures, trajectories and/or other parameters that define the drilling process for the wellsite. The drilling operation may then be performed according to the drilling plan. However, as information is gathered, the drilling operation may deviate from the drilling plan. Additionally, as drilling or other operations are performed, the subsurface conditions may change. The earth model may also provide adjustment as new information is collected.

The data gathered by sensors (S) may be collected by surface unit 134 and/or other data collection sources for analysis or other processing. The data collected by sensors (S) may be used alone or in combination with other data. The data may be collected in one or more databases and/or transmitted on or offsite. The data may be historical data, real time data, or combinations thereof. The real time data may be used in real time, or stored for later use. The data may also be combined with historical data or other inputs for further analysis. The data may be stored in separate databases, or combined into a single database.

Surface unit 134 may include transceiver 137 to allow communications between surface unit 134 and various portions of the oilfield 100 or other locations. Surface unit 134 may also be provided with or functionally connected to one or more controllers (not shown) for actuating mechanisms at oilfield 100. Surface unit 134 may then send command signals to oilfield 100 in response to data received. Surface unit 134 may receive commands via transceiver 137 or may itself execute commands to the controller. A processor may be provided to analyze the data (locally or remotely), make the decisions and/or actuate the controller. In this manner, oilfield 100 may be selectively adjusted based on the data collected. This technique may be used to optimize portions of the field operation, such as controlling drilling, weight on bit, pump rates, or other parameters. These adjustments may be made automatically based on computer protocol, and/or manually by an operator. In some cases, well plans may be adjusted to select optimum operating conditions, or to avoid problems. The surface unit 134 is also depicted as having a microseismic fracture operation system 150 as will be described further herein.

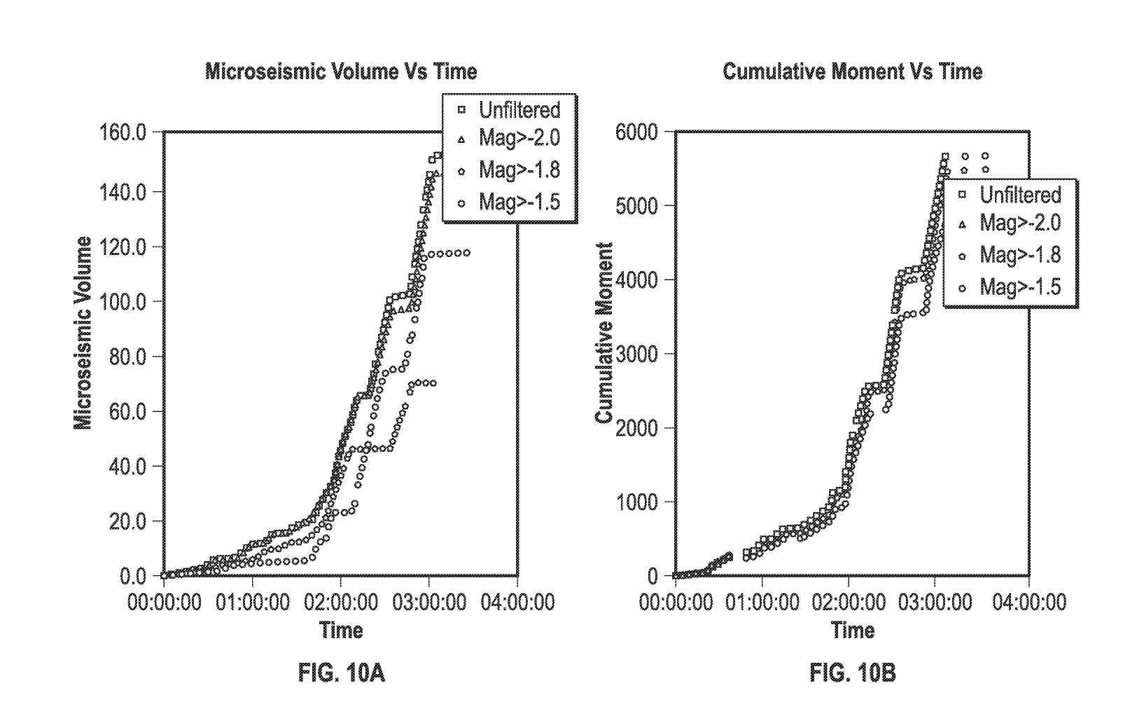

FIG. 10 illustrates a wireline operation being performed by wireline tool 106.3 suspended by rig 128 and into wellbore 136 of FIG. 1B. Wireline tool 106.3 is adapted for deployment into wellbore 136 for generating well logs, performing downhole tests and/or collecting samples. Wireline tool 106.3 may be used to provide another method and apparatus for performing a seismic survey operation. Wireline tool 106.3 may, for example, have an explosive, radioactive, electrical, or acoustic energy source 144 that sends and/or receives electrical signals to surrounding subterranean formations 102 and fluids therein.

Wireline tool 106.3 may be operatively connected to, for example, geophones 118 and a computer 122.1 of the seismic truck 106.1 of FIG. 1A. Wireline tool 106.3 may also include a plurality of geophones to acquire microseismic signals and provide data to surface unit 134. Surface unit 134 may collect data generated during the wireline operation and may produce data output 135 that may be stored or transmitted. Wireline tool 106.3 may be positioned at various depths in the wellbore 136 to provide a survey or other information relating to the subterranean formation 102.

Sensors (S), such as geophones and/or gauges, may be positioned about oilfield 100 to collect data relating to various field operations as described previously. As shown, sensor S is positioned in wireline tool 106.3 to measure downhole parameters which relate to, for example porosity, permeability, fluid composition, microseismic signals and/or other parameters of the field operation.

FIG. 1D illustrates a production operation being performed by production tool 106.4 deployed from a production unit or Christmas tree 129 and into completed wellbore 136 for drawing fluid from the downhole reservoirs into surface facilities 142. The fluid flows from reservoir 104 through perforations in the casing (not shown) and into production tool 106.4 in wellbore 136 and to surface facilities 142 via gathering network 146.

Sensors (S), such as gauges, may be positioned about oilfield 100 to collect data relating to various field operations as described previously. As shown, the sensor (S) may be positioned in production tool 106.4 or associated equipment, such as Christmas tree 129, gathering network 146, surface facility 142, and/or the production facility, to measure fluid parameters, such as fluid composition, flow rates, pressures, temperatures, and/or other parameters of the production operation.

Production may also include injection wells for added recovery. One or more gathering facilities may be operatively connected to one or more of the wellsites for selectively collecting downhole fluids from the wellsite(s).

While FIGS. 1B-1D illustrate tools used to measure properties of an oilfield, it will be appreciated that the tools may be used in connection with non-oilfield operations, such as gas fields, mines, aquifers, storage, or other subterranean facilities. Also, while certain data acquisition tools are depicted, it will be appreciated that various measurement tools capable of sensing parameters, such as seismic two-way travel time, density, resistivity, production rate, etc., of the subterranean formation and/or its geological formations may be used. Various sensors (S) may be located at various positions along the wellbore and/or the monitoring tools to collect and/or monitor the desired data. Other sources of data may also be provided from offsite locations.

The field configurations of FIGS. 1A-1D are intended to provide a brief description of an example of a field usable with oilfield application frameworks. Part, or all, of oilfield 100 may be on land, water, and/or sea. Also, while a single field measured at a single location is depicted, oilfield applications may be utilized with any combination of one or more oilfields, one or more processing facilities and one or more wellsites.

FIG. 1E depicts the microseismic fracture operation system 150. As shown, the microseismic fracture operation system 150 includes a microseismic tool 152, a fracture tool 154, a wellsite tool 156, an optimizer 158 and an oilfield tool 160. The microseismic tool 152 may be used to acquire and analyze microseismic signals indicative of microseismic events induced by the fracturing operation. The fracture tool 154 may be used to perform fracture extraction. The wellsite tool 156 may be used to generate fracture attributes, such as permeabilities. The optimizer 158 may be used to perform dynamic modeling and adjust the fracture attributes based on the dynamic modeling. The oilfield tool 160 may be used to obtain wellsite data from, for example, the sensors S from FIGS. 1A-1D and manipulate the data as needed for use by the other tools of the microseismic fracture operation system 150. Each of these functions is described further herein.

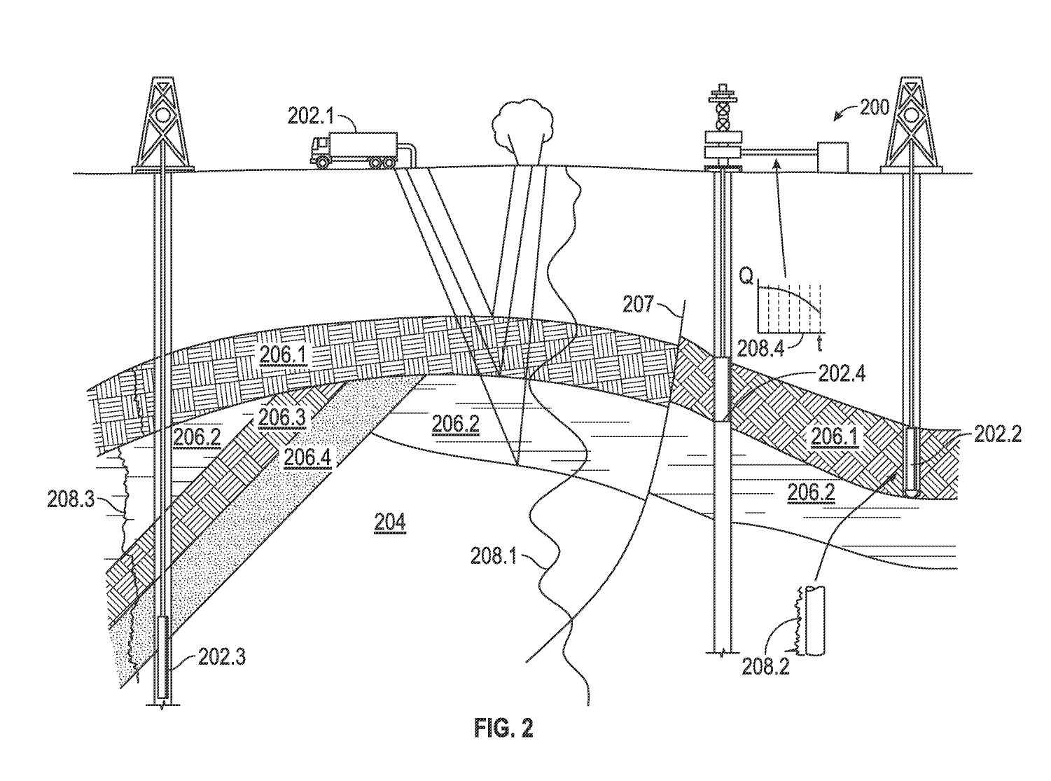

FIG. 2 illustrates a schematic view, partially in cross section of oilfield 200 having data acquisition tools 202.1, 202.2, 202.3 and 202.4 positioned at various locations along oilfield 200 for collecting data of subterranean formation 204 in accordance with implementations of various technologies and techniques described herein. Data acquisition tools 202.1-202.4 may be the same as data acquisition tools 106.1-106.4 of FIGS. 1A-1D, respectively, or others not depicted. As shown, data acquisition tools 202.1-202.4 collect data that can be used to generate data plots or measurements 208.1-208.4, respectively. These data plots are depicted along oilfield 200 to demonstrate the data generated by the various operations.

Data plots 208.1-208.3 are examples of static data plots that may be generated by data acquisition tools 202.1-202.3, respectively, however, it should be understood that data plots 208.1-208.3 may also be data plots that are updated in real time. These measurements may be analyzed to better define the properties of the formation(s), the effectiveness of the stimulation operation, and/or to determine the accuracy of the measurements and/or for checking for errors. The plots of each of the respective measurements may be aligned and scaled for comparison and verification of the properties.

Static data plot 208.1 is a seismic two-way response over a period of time. Static plot 208.2 is core sample data measured from a core sample of the formation 204. The core sample may be used to provide data, such as a graph of the density, porosity, permeability, stiffness (as may be measured by the shear modulus) or some other physical property of the core sample over the length of the core. Tests for density and viscosity may be performed on the fluids in the core at varying pressures and temperatures. Static data plot 208.3 is a logging trace that may provide a resistivity or other measurement of the formation at various depths.

A production decline curve or graph 208.4 is a dynamic data plot of the fluid flow rate over time. The production decline curve may provide the production rate as a function of time. As the fluid flows through the wellbore, measurements are taken of fluid properties, such as flow rates, pressures, composition, etc.

Other data may also be collected, such as historical data, user inputs, economic information, and/or other measurement data and other parameters of interest. As described below, the static and dynamic measurements may be analyzed and used to generate models of the subterranean formation to determine characteristics thereof, or models of the results of the stimulation operation. Similar measurements may also be used to measure changes in formation aspects over time.

The subterranean structure 204 has a plurality of geological formations 206.1-206.4. As shown, this structure has several formations or layers, including a shale layer 206.1, a carbonate layer 206.2, a shale layer 206.3 and a sand layer 206.4. A fault 207 extends through the shale layer 206.1 and the carbonate layer 206.2. The static data acquisition tools are adapted to take measurements and detect characteristics of the formations.

While a specific subterranean formation with specific geological structures is depicted, it will be appreciated that oilfield 200 may contain a variety of geological structures and/or formations, sometimes having extreme complexity. In some locations, for example below the water line, fluid may occupy pore spaces of the formations. Each of the measurement devices may be used to measure properties of the formations and/or its geological features. While each acquisition tool is shown as being in specific locations in oilfield 200, it will be appreciated that one or more types of measurement may be taken at one or more locations across one or more fields or other locations for comparison and/or analysis.

The data collected from various sources, such as the data acquisition tools of FIG. 2, may then be processed and/or evaluated. The seismic data displayed in static data plot 208.1 from data acquisition tool 202.1 is used by a geophysicist to determine characteristics of the subterranean formations and features. The core data shown in static plot 208.2 and/or log data from well log 208.3 may be used by a geologist to determine various characteristics of the subterranean formation. The production data from graph 208.4 may be used by the reservoir engineer to determine fluid flow reservoir characteristics. The data analyzed by the geologist, geophysicist and the reservoir engineer may be analyzed using modeling techniques.

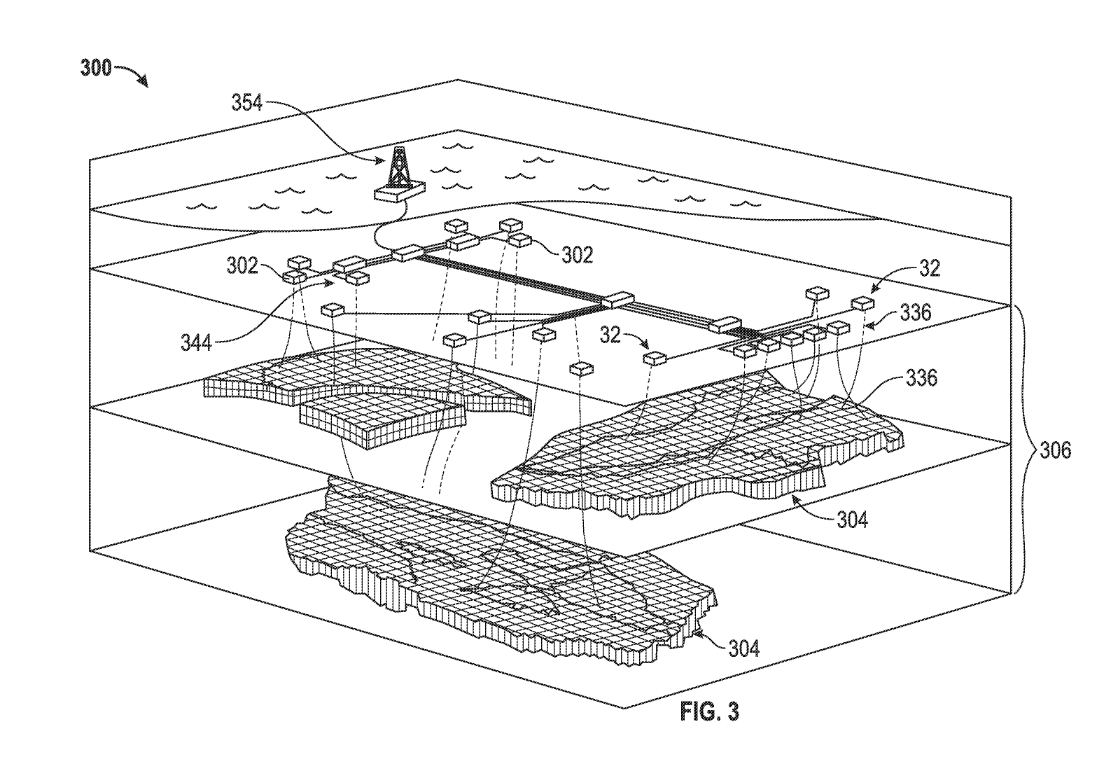

FIG. 3 illustrates an oilfield 300 for performing production operations in accordance with implementations of various technologies and techniques described herein. As shown, the oilfield has a plurality of wellsites 302 operatively connected to central processing facility 354. The oilfield configuration of FIG. 3 is not intended to limit the scope of the oilfield application system. Part or all of the oilfield may be on land and/or sea. Also, while a single oilfield with a single processing facility and a plurality of wellsites is depicted, any combination of one or more oilfields, one or more processing facilities and one or more wellsites may be present.

Each wellsite 302 has equipment that forms wellbore 336 into the earth. The wellbores extend through reservoirs 304 of the subterranean formations 306. These reservoirs 304 contain fluids, such as hydrocarbons. The wellsites draw fluid from the reservoirs and pass them to the processing facilities via surface networks 344. The surface networks 344 have tubing and control mechanisms for controlling the flow of fluids from the wellsite to processing facility 354. Some of the wellbores 336 may also be used to monitor microseismic events occurring near other wellbores 336.

### Introduction—Part 1

The present disclosure describes a methodology for performing a well stimulation operation, such as a microseismic facture operation, or a well acidizing operation. This well stimulation operation may involve generating various wellsite parameters, such as fracture attributes (e.g., fracture width, porosity, permeability and factors used in fracture simulations) and production properties (e.g., production rate). This well stimulation operation may also be used to predict fracture geometry by providing time-based information with respect to two-dimensional or three-dimensional locations of microseismic events.

Unlike bi-wing hydraulic fractures created in conventional reservoirs, fracture networks created in shale-gas reservoirs may be complex in nature. These complex fractures may have an impact on the well performance, and the nature and degree of the fracture complexity may be understood to select the optimum stimulation design and completion strategy. Microseismic mapping has been used in the development of shale-gas reservoirs, and has confirmed the existence of complex fracture growth.

Wellsite modeling software capable of performing, for example, reservoir, geological and geophysical modeling may be used in performing the modeling. The software may be, for example, PETREL™ software, a technology commercially available from SCHLUMBERGER™, Ltd. of Houston, Tex. (referred to herein as “PETREL™”). For simplicity and by way of example, the methods described herein will be described with respect to PETREL™, but may be used with any modeling software.

According to an aspect of the present disclosure, one or more embodiments relate to microseismic measurements during a well stimulation operation, such as a hydraulic fracturing treatment. One or more embodiments presented herein provide insights into the behavior and/or effectiveness of the hydraulic fracture treatments. Engineering evaluations of microseismic data have traditionally been based upon the microseismic event locations and the times that the events were detected during the treatment. Visualization aids such as the dimensions of the event clouds and an estimate of the reservoir volume where microseismic activity has been detected aid in the evaluation. The event locations can be displayed in a geological context using information that has been provided for the engineering evaluation.

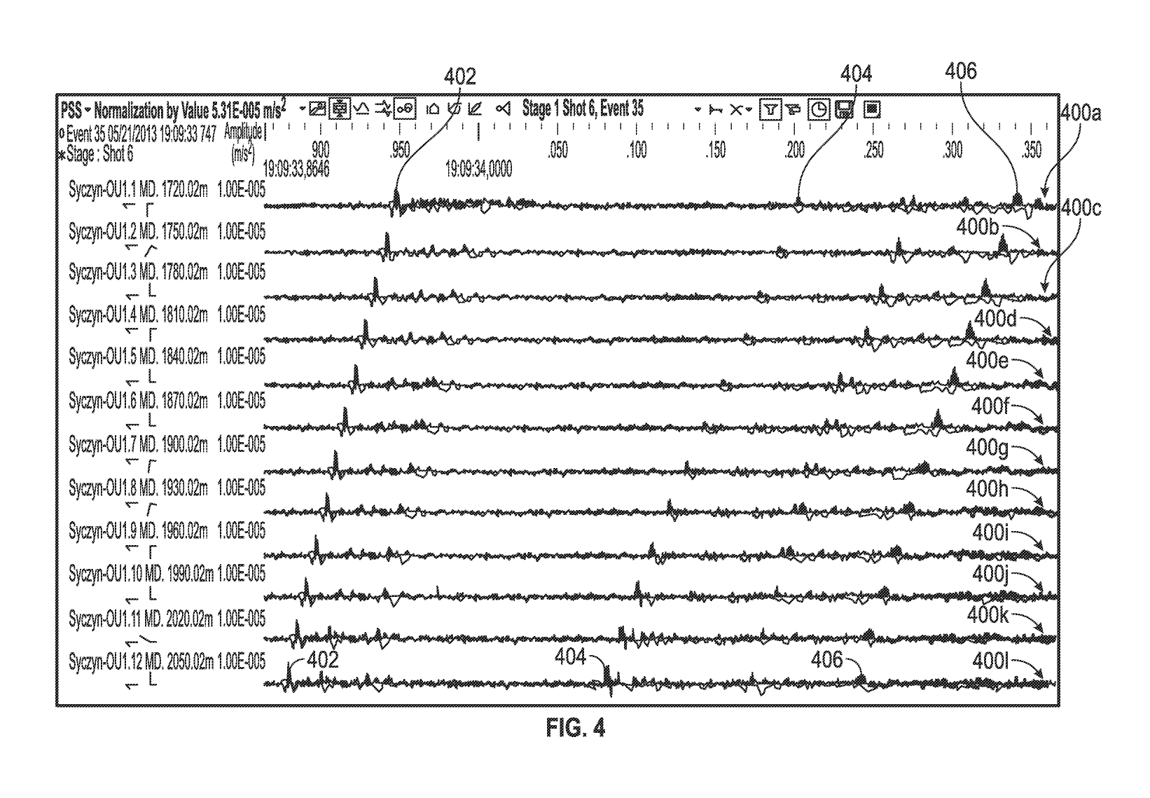

FIG. 4 shows twelve exemplary microseismic signals 400 that are received during a period of time by data acquisition tools 202.4 comprising one or more geophones located in a monitoring well at a known location relative to the formation. The microseismic signals include compression waves 402, shear horizontal waves 404 and shear vertical waves 406 (collectively “waveforms”) indicative of the microseismic event generating the microseismic signals. The microseismic signals 400 also include amplitudes as shown in FIG. 4. The compression waves 402, shear horizontal waves 404 and shear vertical waves 406 travel through the Earth at different speeds and are received by the geophones at different times. The relative locations of the geophones and the time of receipt of the compression waves 402, shear horizontal waves 404 and shear vertical waves 406 can be used by software to calculate the location of the microseismic event in a well-known manner. The location of the microseismic event is known in the art as the “hypocenter.” Techniques for determining the location of the geophones and the microseismic events are set forth in United States Patent Publication No. 2011/0069584, titled “Method of Locating a Receiver in a Well,” the entire content of which is hereby incorporated herein by reference.

The location of the microseismic event can also be determined as follows. The microseismic signals can be 3C traces recorded at each geophone “r”, at time samples, “t”, rotated to the geographic coordinate system: Eᵣ(t), Nᵣ(t), Uᵣ(t). The 3C energy envelope of the traces is defined as follows:

Enᵣ(t)=H[Eᵣ(t)]²+H[Nᵣ(t)]²+H[Uᵣ(t)]² (1)

where H[f(t)] signifies the envelope computation using the Hilbert transform of the function f(t).

The compression waves 402 will be referred to hereinafter as “P-waves” and the shear horizontal waves 404 and shear vertical waves 406 are referred to hereinafter as the “S-waves.” From the 3C energy, the signal to noise ratios for P- and S-waves, SNRPᵣ(t) and SNRSᵣ(t), are computed taking time window lengths for signal and noise time windows, stwp and ltwp, respectively:

$$SNR {P}_{r} ( t ) = \frac{ltwp}{stwp} \frac{{\sum }_{j = t}^{stwp + t - 1} {En}_{r} ( j )}{{\sum }_{j = t - ltwp - 1}^{t} {En}_{r} ( j )} \qquad ( 2 )$$

As S-waves have different frequency content than P-waves, the signal to noise for S-waves, SNRSr(t), is computed taking different short and long time window lengths, stws and, ltws, respectively.

The real-time location algorithm proceeds in two steps: a detection step, where an estimate of t₀ and location is made, and a location step, where the estimated t₀ and polarizations are used. In both cases a map based on Equation (2) is used.

From the signal to noise ratio for P- and S-waves, the detection map, Det(t,x,y,z), is computed for each time sample, t, and grid node, (x,y,z). The value of the detection map is the product of SNRPᵣ(t) and SNRSᵣ(t) at the modeled P- and S-wave arrival times, tpᵣ(x,y,z) and tsᵣ(x,y,z) over all geophones, r.

$$Det ( t , x , y , z ) = {\prod }_{r = 1}^{nr} SNR {P}_{r} ( t + {tp}_{r} ( x , y , z ) ) * SNR {S}_{r} ( t + {ts}_{r} ( x , y , z ) ) \qquad Equation ( 3 )$$

When the maximum value of the detection map exceeds a given threshold, then the event is considered detected. Its origin time, t₀, is the time of the maximum of the detection map and the origin time uncertainty, σt₀, is the time range where the maxima of the detection map around the time, t₀, exceed 50% of the maximum at the estimated origin time.

Over the time window, σt₀, at the origin time, t₀, the location step is then performed. The location requires information about the direction of the incoming energy at each receiver. One solution is to compute a probability function based on the continuously estimated P-wave polarization vector, vmᵣ(t) and its uncertainty, σᵣ(t). For each grid position (x,y,z) a probability function is computed taking into account the P-wave modeled polarization vector, vpᵣ(x,y,z) as follows:

$${PDF}_{pol} ( x , y , z ) = {\prod }_{r = 1}^{nr} {\prod }_{i = 1}^{3} \frac{1}{\sqrt{2 π} {σ}_{ri} ( t )} {e}^{- {[ \frac{{vm}_{ri} ( t ) - {vp}_{ri} ( x , y , z )}{2 {σ}_{ri} ( t )} ]}^{2}} . \qquad ( 4 )$$

The location map is then computed from the detection map values and the polarization probability function as follows:

$$Loc ( x , y , z ) = \frac{1}{σ {t}_{o}} {\sum }_{t = {t}_{o} - σ {t}_{o / 2}}^{{t}_{o} + σ {t}_{o / 2} + 1} Det ( t , x , \vert y , z ) {PDF}_{pol} ( x , y , z ) \qquad ( 5 )$$

Note: the notation presents the case where the velocity model is isotropic. In the case of Tl velocity model, the times and polarization angles for P and Sh waves are computed and used.

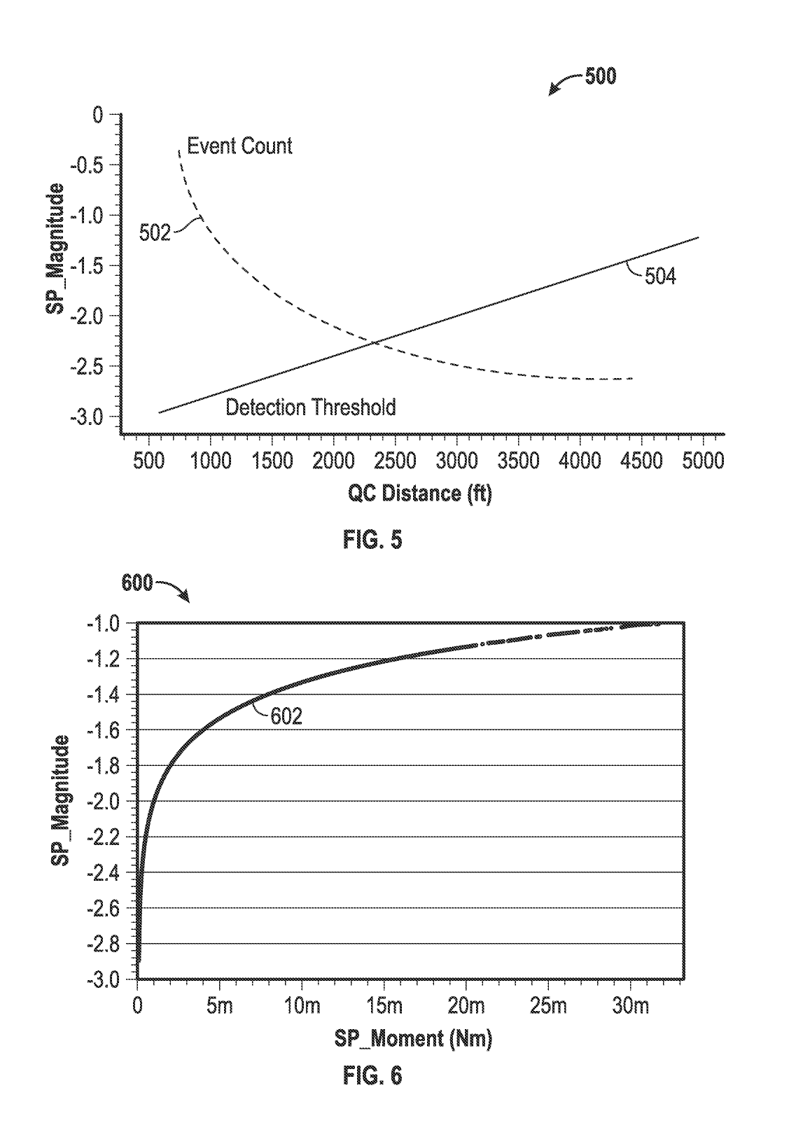

Shown in FIG. 5, is a graph 500 showing a magnitude versus distance plot and a relationship to microevent counts 502. The ability of the geophones to detect microseismic events at a given distance from the geophone locations generally depends on the amplitude of the waveforms at the source location. As the distance between the microseismic event and the geophones increases, correspondingly larger minimum amplitudes are necessary for detection due to attenuation of the amplitudes of the microseismic signals as the microseismic signals travel to the location of the geophones. This relationship is shown in FIG. 5 with a detection threshold 504. For a given distance, microseismic events having an amplitude above the detection threshold can be detected, while microseismic events having an amplitude below the detection threshold cannot be detected.

Microseismic activity produces microseismic events with a range of source amplitudes. As a distance between the microseismic event and the geophones change, the numbers of microseismic events detected may also change. This relationship can be visualized through computation of the moment-magnitude of the microseismic events and displaying the observed magnitudes versus distance. The detection threshold 504 can be determined from the magnitude versus distance relationship is a minimum event magnitude that can be detected at a given distance. The statistical distribution of microseismic event magnitudes is such that under constant rock and monitoring conditions, the numbers of microseismic events that can be detected decreases exponentially with distance.

The reduction in event count with distance can affect the evaluation of microseismic activity during the hydraulic fracturing completion of wells where the well stimulation operations are performed over large ranges of distances from the monitoring sites where the geophones are located. Qualitative comparisons of the dimensions of the event clouds and estimates of the reservoir volume that has been stimulated, both of which depend on the total number and location of detected events, will therefore be affected if no compensation is made for detectability as the distance changes.

Shown in FIG. 6 is a graph 600 showing a relationship 602 between moment and magnitude. The magnitude values that are used in the magnitude versus distance plot are a direct conversion from the moment values of the microseismic events. The moment value of each microseismic event can be determined using the amplitudes of the detected waves and the frequency content of the waveforms. The range of values shown is typical of the microseismic events observed during fracturing treatments.

The cumulative seismic moment, which is the arithmetic sum of the event moments, can be used to make qualitative comparisons of the microseismic response during multiple-stage completions. Cumulative moment development as a function of time can be compared with the fracture treatment parameters. Variations in the rate that cumulative moment develops can potentially be correlated with pressure response, fluid type, injection rates, or other aspects of the fracturing treatment. Cumulative moment can also be computed using spatial dimensions such as depth.

The advantage to using the moment values for qualitative evaluation of stimulation operation response compared to microseismic dimensions or stimulated volume estimates is that it is much less sensitive to monitor well bias. Monitor well bias affects the detection of the weaker microseismic events whose moment values are relatively low. Those events have low moment values and therefore have a minimal effect on the total, or cumulative, moment value of the microseismic events detected during well stimulation operations. It is this property of the moment values that permits its use and extends the range of evaluation beyond distances where the stimulated volume can be characterized.

### Seismic Moment and Moment-Magnitude

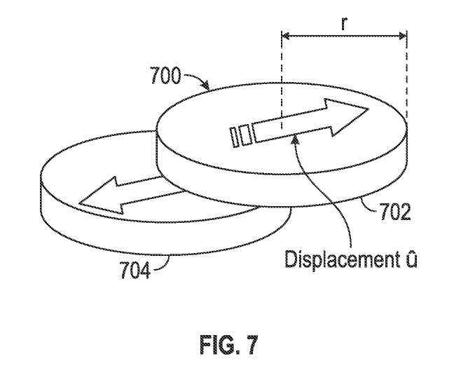

FIG. 7 illustrates a partial perspective view of a rock 700 fracturing into a first rock 702 and a second rock 704 in which the second rock 704 moves relative to the first rock 702 resulting in a microseismic event having a moment. Seismic moment is a measurement of the deformation that produces the microseismic event. Moment can be expressed mathematically as the product of the shear modulus of the rock, G, the area of the slip, A, and the displacement, ü, that has occurred as shown in Equation (6). The displacement has a directional component as shown by the arrows in FIG. 7. FIG. 7 is a conceptual model of a type of deformation that produces compressional and shear waves that are used to identify and locate the deformation and identify the deformation as a microseismic event.

Mo=G*A*û (6)

Since it is not possible to resolve the area of the failure or the size of the displacement when only a single array of geophones is in use, only the relative size of the deformations can be measured. The assumption that the shear modulus remains constant is implicit in this evaluation. Significant changes in shear modulus that might result from variations in lithology will affect the moment values of events with similar deformation when they occur in different types of rock.

Changes in rock properties might have an effect on the observations of deformation, but can be removed if the geological model is defined and the rock properties are known. If those properties are not defined, then the moment values can be used for the evaluation.

When modeling the type of microseismic event that has occurred, one skilled in the art understands that there are at least two relevant aspects of the source deformation that provides insight into the geomechanical deformations of the fractures resulting in the microseismic events. The first is the scalar seismic moment (Mo), which relates the microseismic source strength to the coseismic strain measure via the product of the slip area (A) and displacement û as shown in Equation (6).

The magnitude measure of the microseismic source strength can be estimated by the moment magnitude (Mw) using Equation (7) set forth below.

Mw=⅔ log(Mo)−6 (7)

The slip displacement or strain is an attribute that can be directly estimated with a numeric geomechanical simulation, such that equivalent moments or moment magnitudes can be estimated from the simulation.

The second relevant aspect of the microseismic event is known as a source focal mechanism. Focal mechanisms can be used to estimate the fracture orientation of the microseismic event using a variety of methods, such as moment tensor inversion methods to estimate the mode of the microseismic source slip and whether shear, tensile opening or a combination has occurred. For a given fracture segment orientation within a discrete fracture network, geomechanical simulations can also predict the comparable mode of slip.

### Cumulative Moment Method of Analysis

In evaluating microseismic data, one might consider that the events may be affected both by variability in the quality of the signals that are detected and spatial bias associated with variations in the source-receiver distances, e.g., the distance between the microseismic event and the monitoring location where the geophones are located. Variations in signal quality contribute to the uncertainty associated with locating the event hypocenters. The numbers of microseismic events detected either increase or decrease with distance.

Uncertainty can be minimized through careful examination of the parameters associated with the detection and location of microseismic events. The selection of the filters that may be used to minimize these effects might be different depending on the type of evaluation being performed. One challenge facing the evaluator is determining the optimal balance between location confidence and the number of microseismic events used for the evaluation.

Minimizing the effects of monitor well bias is more difficult. The confidence in the dimensions and presumed orientation of the microseismic event clouds used to evaluate the geometry of the fracture(s) created during a well stimulation operation increases with the number of events available for the evaluation. The stimulated volume, which is based (at least in part) on the density of the microseismic events within investigated volume of rock, is also heavily dependent upon event count. A comparison of the effects that monitor well bias has on stimulated volume calculations and cumulative moment calculations is shown below in FIGS. 10-1 and 10-2.

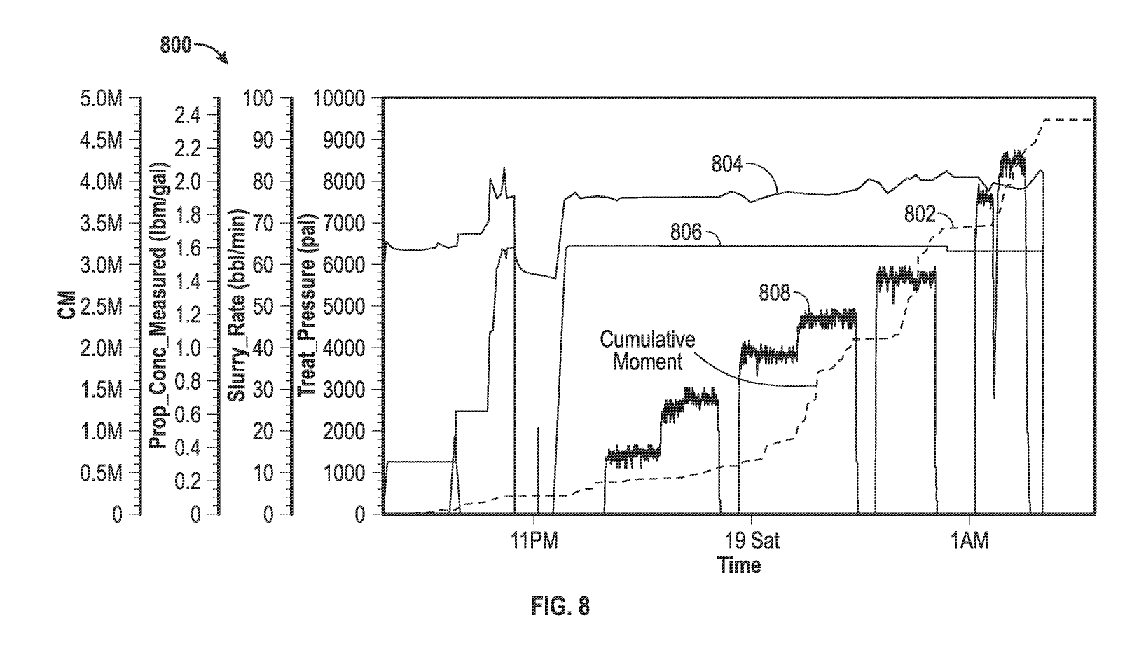

Shown in FIG. 8 is a graph 800 of an exemplary cumulative moment plot 802 in which the construction of the cumulative moment plot 802 comprises the sum of the individual event moments plotted against time, or injected volume, to visualize changes in deformation rate that might occur during a well stimulation operation. The exemplary cumulative moment plot 802 includes pressure and rate data from a typical fracturing treatment. The rate at which the deformation occurs during the well stimulation operation is not constant. In the example shown the increase in the rate that cumulative moment develops appears to occur with a corresponding increase in the observed surface pressure. Also shown in FIG. 8 are plots for surface treatment pressure 804, pumping rate 806 and proppant concentration 808.

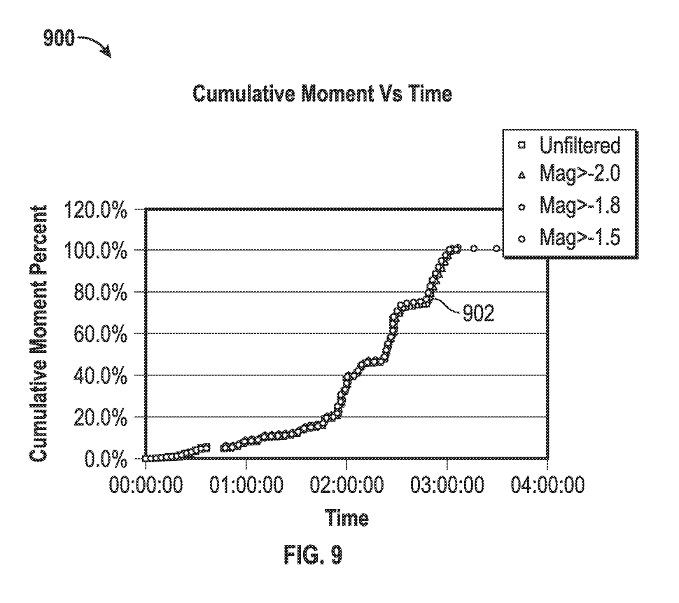

FIG. 9 illustrates a graph 900 showing individual microseismic moments 902 occurring over a time period that have been normalized with the cumulative moment. In accordance with the present disclosure, cumulative moment can be used qualitatively to compare the responses of well stimulation operations by a process that reconciles differences in the numbers of microseismic events detected. The development of the cumulative moment is used to normalize the moments of the microseismic events by computing the fractional value of each moment contributing to the total cumulative moment versus time. In the example shown the fractional value used is the percentage of the total moment value. This process minimizes the effect of monitor well bias with the result that there is little difference in the observed rate that deformation occurs at various distances from the location of the geophone receivers.

Total values of the cumulative moment can be affected by total numbers of microseismic events detected, but the rate at which the cumulative moment develops may be similar unless there is a change in reservoir conditions or the well stimulation operation schedule is altered. The conversion from total values to fractional values using a percentage minimizes the effects of monitor well bias. A cumulative moment response can be observed even when event counts fall below the threshold where microseismic volumes can be defined.

Comparisons of microseismic responses using cumulative moment, based on the observed deformation rates, can be used to compare microseismic responses that occur over a broader range of monitoring distances than microseismic volume evaluations. The reason for this is that the individual moments for lower magnitude events that are more susceptible to monitor well bias are relatively small and contribute only a small percentage of the total moment. Microseismic events with higher magnitudes are readily detected throughout the volume of rock being monitored and contribute proportionally more to the total of the cumulative moment.

### Application of Cumulative Moment to Evaluation

Cumulative moment provides a means to visualize the time and rate that deformations occur while fracturing is in progress. As shown previously, cumulative moment is relatively insensitive to monitor well bias and is less dependent upon high event counts than frequency-versus-magnitude plots.

The addition of cumulative moment supplements the visualization of event locations, the dimensions of the event cloud, and volume calculations. It is often difficult to observe changes in microseismic response visually, but any changes in the deformation rate will be readily apparent in the cumulative moment values.

Compensating for changes in microseismic event counts that occur as a result of monitor well bias is easily accomplished by displaying the cumulative moment development in time as a percentage of its final value. Another option is to compute a derivative of the microseismic moments, and use the rate of change as an evaluation tool for real-time applications.

Normalizing the microseismic moments as a percentage of cumulative moment provides a simple but effective means to evaluate microseismic response as a function of time or injected volume. Direct comparison of the deformations can then be made in order to identify changes in response that might have occurred during one or more well stimulation operations and interpret those changes using the data that is available.

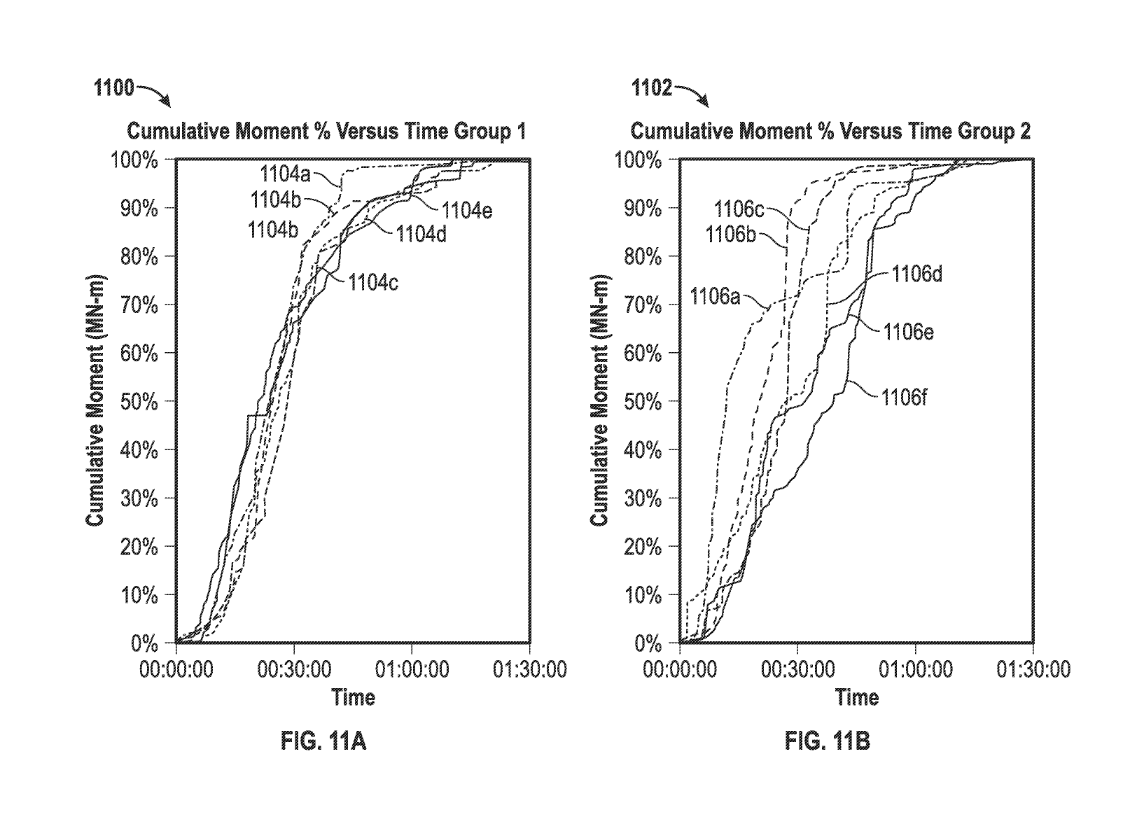

FIGS. 11A and 11B illustrate graphs 1100 and 1102 showing variability in microseismic responses to the well stimulation operation in which multiple sets of cumulative moments 1104a-e and 1106a-f of microseismic events are depicted over a time period. The following example is a comparison of the cumulative moment development as a function of time from two separate groups of well stimulation operations performed in the same well but under different conditions. The variability in the sets of individual microseismic responses normalized by cumulative moment in graph 1100 is much less than the variability in the multiple sets shown in graph 1102. The variability of the multiple sets shown in graph 1102 may be related to a specific aspect of the completion procedure. Each of the sets 1104a-e and 1106a-f can be for a specific and separate well stimulation operation.

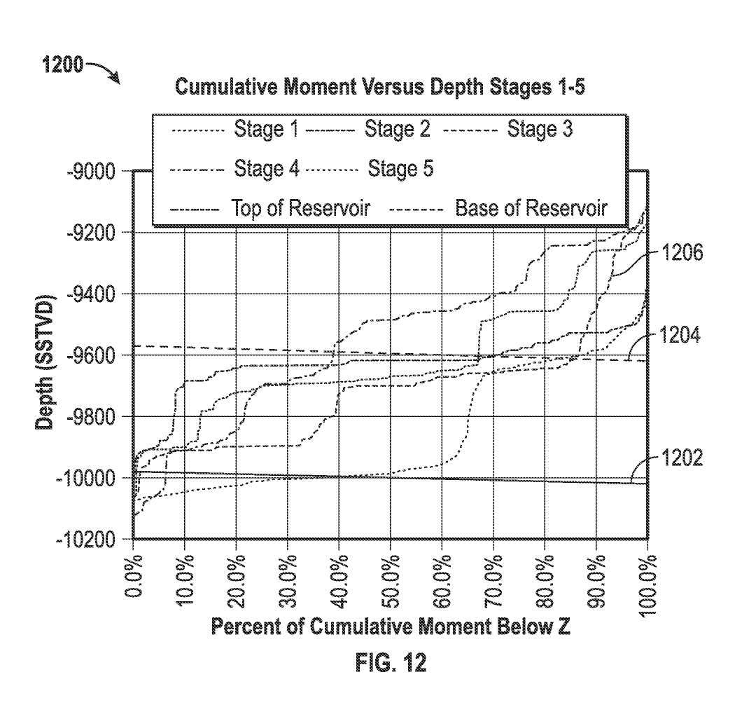

Cumulative moment can also be used and displayed in the spatial domain as shown in FIG. 12. FIG. 12 illustrates a graph 1200 depicting multiple sets of individual microseismic event moments that have been normalized as a percentage of cumulative moment versus depth of the individual microseismic events. In this example, the cumulative moment has been computed according to the depth of the microseismic events, to map changes in deformation that occur vertically within the fracture system.

Shown on the graph 1200 is indicia 1202 depicting the base of a reservoir, indicia 1204 depicting a top of the reservoir, and multiple sets of indicia 1206 showing the cumulative moment according to depth.

FIG. 12 shows that the distribution of deformations that have occurred during the well stimulation operations shown is not consistent from stage to stage. Increased deformation occurs above the top of the reservoir as the completion progresses from stage 1 to stage 5.

Evaluations shown in FIG. 12 might be useful when microseismic data has been gathered to study the effects of well placement on fracture geometry. The evaluation also provides some evidence that the stresses induced by previous well stimulation operations during the completion cause a change in the geometry of the subsequent stimulation operations.

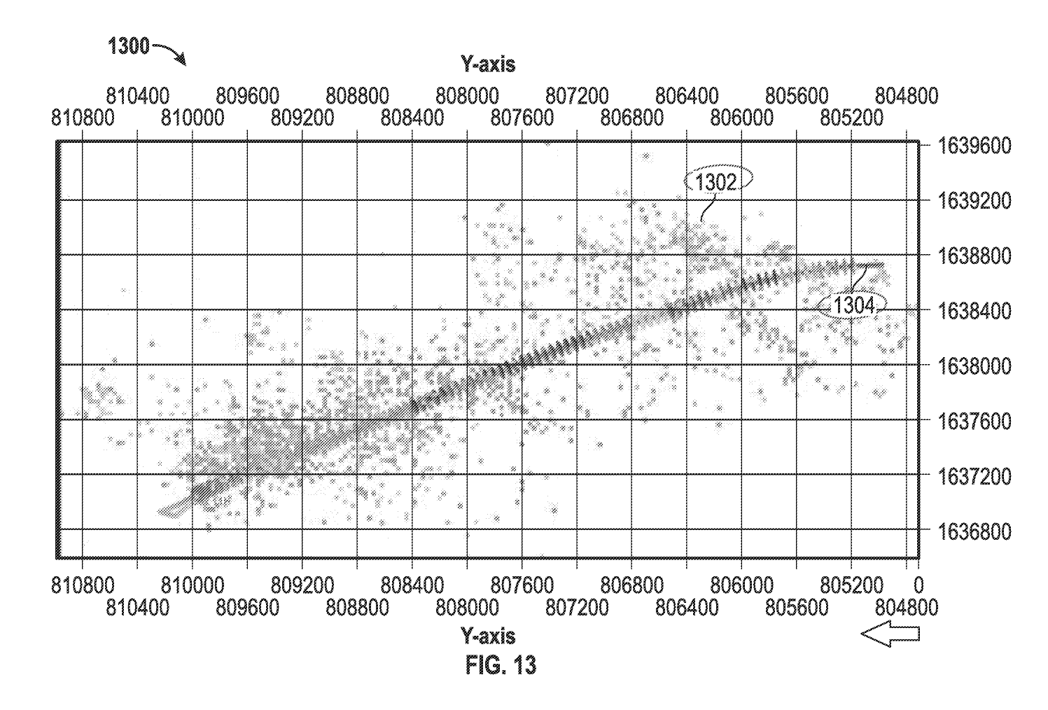

FIG. 13 illustrates a graph 1300 showing a three-dimensional location of individual microseismic events 1302 and a portion of a wellbore 1304 that has undergone a well stimulation operation resulting in the microseismic events in accordance with implementations of various technologies and techniques described herein. Mapping of the deformation observed during a well stimulation operation using the cumulative moment can be used to evaluate the output of fracture models. For this application the moment values are plotted as a grid in a geological model that can be viewed using a specialized software package, such as the software package known as Petrel, discussed above. Thus the moment values can be visualized in a geological context as shown below and viewed in any orientation that the user chooses. The colors range from a minimum displayed value (blue) to a maximum displayed value (red). The actual values for each cell are the sum of the moment values of any microseismic events located within an individual cell.

Once loaded into the viewer model, the fractional value of the total moment in each cell is easily calculated. The results can then be compared to the fracture model output to assess the validity of the modeling results.

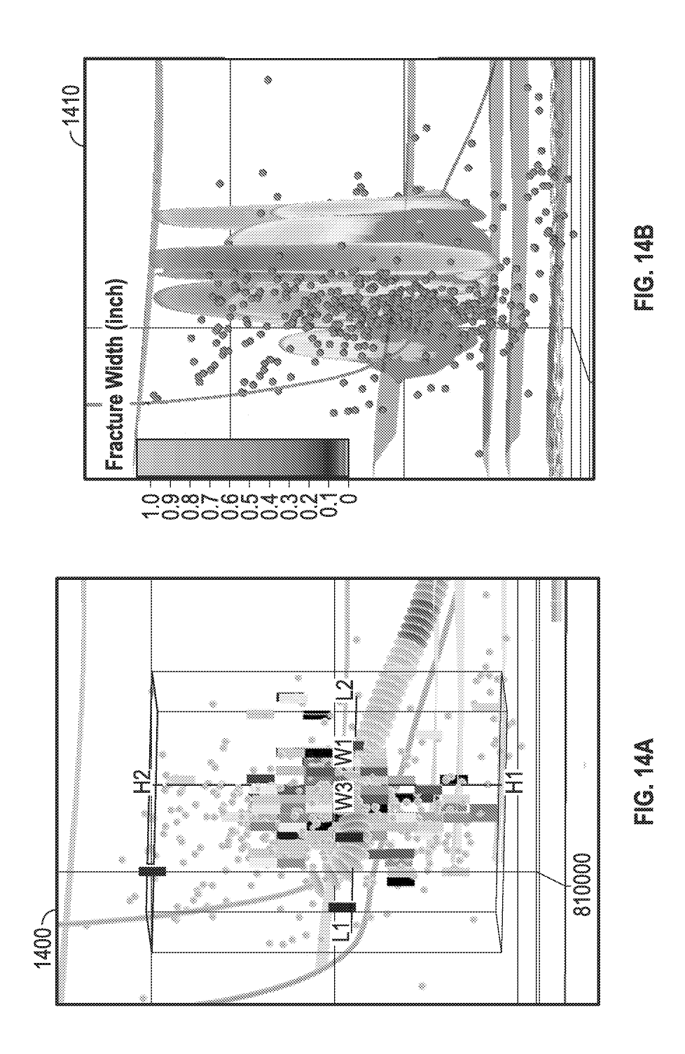

FIGS. 14A and 14B illustrate a three-dimensional model having mapped deformation based on fractional values of the cumulative moment and comparison to modeled fracture geometry for a single treatment stage. FIG. 14A shows a deformation map 1400 of the fractional moment values, and the locations of the microseismic events. Note that some events do not contribute to the deformation map. On the right is a model 1410 of the fracture geometry using a model specifically designed for unconventional reservoirs. The pattern and distribution agrees with the deformation map and in particular the effects that a thin layer has on the modeled and observed fracture geometries.

### Effects of Shear Modulus (Future Development)

The assumption that has been implicit in the discussion of the application of moment and moment-magnitude to microseismic evaluation is that the shear modulus of the rock being stimulated remains relatively constant. This is not always the case, and consideration must be made for the possible effect that variations in shear moduli in different layers might have on the evaluation. This is not possible when using event locations and times. It is possible if the events can be placed in a geological model that includes the geomechanical properties of the rock.

As seen in Equation (6), the moment value is the product of the shear modulus and the deformation. In most applications the shear moduli of the reservoir rock and bounding zones are not known. An assumption can be made that there is little or no horizontal variability of the shear modulus since the rocks were deposited at the same time and have been subject to same geological history. For the purposes of this discussion, variations in shear moduli are assumed to have only a secondary effect on the observed moment values of the microseismic events. Differences in the areas of the failures and associated displacements are the source of the majority of the variability that is observed in the computed microseismic event source parameters. Although the areas and displacements may not be separated mathematically, the product of the two terms is the deformation that is of interest for the evaluation of fracture response. The deformations occur as a direct result of the fracturing operations; therefore it should be possible to use the moment values to determine when, where, and at what rate deformation takes place during a stimulation treatment.

Dividing each moment by the shear modulus of the rock where the event has been located provides a deformation value that has units of length cubed. Separation of the deformation into its components of area and displacement requires inversion of the moment tensor which can be accomplished only under limited conditions. The moment values have been calculated using assumed total deformations and various values for shear modulus. The results show that significant variations in rock properties can affect the relative strength of the detected events, which might have an effect both on event detection (magnitude) and the visualization of the events themselves.

The location and time that microseismic events occur during a well stimulation operation can be used during the evaluation of well stimulation operations to define maximum dimensions of the fracture network and determine a volume where well stimulation operations have occurred. Results are often used qualitatively to compare the results of multiple well stimulation operations within a single well or group of wells in an effort to determine the optimum well placement, completion design, and well stimulation procedure for that reservoir.

Two factors that impede such evaluation are uncertainties associated with microseismic event locations, and a reduction in event detection that occurs when the source-receiver distances increase. Conditioning microseismic events that have been detected over a large range of monitoring distances to provide a consistent visual representation that reduces the effects of location quality and monitoring distance is difficult. The ability to visualize the microseismic responses and estimate the dimensions and volumes used for comparison is diminished when the numbers of events used for evaluation decreases. The data conditioning process can in some cases reduce the number of usable events to a level where evaluation of dimensions and volumes no longer provides reliable comparisons.

Evaluation tools that utilize the moment and moment-magnitude of the microseismic events supplement the evaluations that are based on event locations and times. Cumulative moment provides a means to visualize the rate that deformations associated with fracturing activity occur during a well stimulation operation. The cumulative moment plots can be normalized to minimize the effects of variations in event count that occur with changing distances. Cumulative moment calculations are less sensitive to monitor well bias than volume calculations and therefore can be useful when distances from the monitoring tools increase beyond the point where volumes can be reliably computed. Cumulative moments can be evaluated in both the time domain and spatial domains depending upon the objectives of the evaluation.

Interpretations of the changes observed in frequency-versus-magnitude and cumulative moment responses require attention to the completion configuration, well stimulation operation design, and reservoir properties. However, these tools expand the ability to evaluate microseismic responses during well stimulation operations beyond the capabilities of dimensions and volumes. Complex projects with large numbers of operations in a variety of completion configurations with varying operation designs can easily be compared to one another. Anomalies and departures from expected behavior can be easily identified for further analysis. The use of the microseismic event source parameters related to the deformations that have occurred is a valuable addition to microseismic evaluations.

### Computer System and Methodologies for Oilfield Application

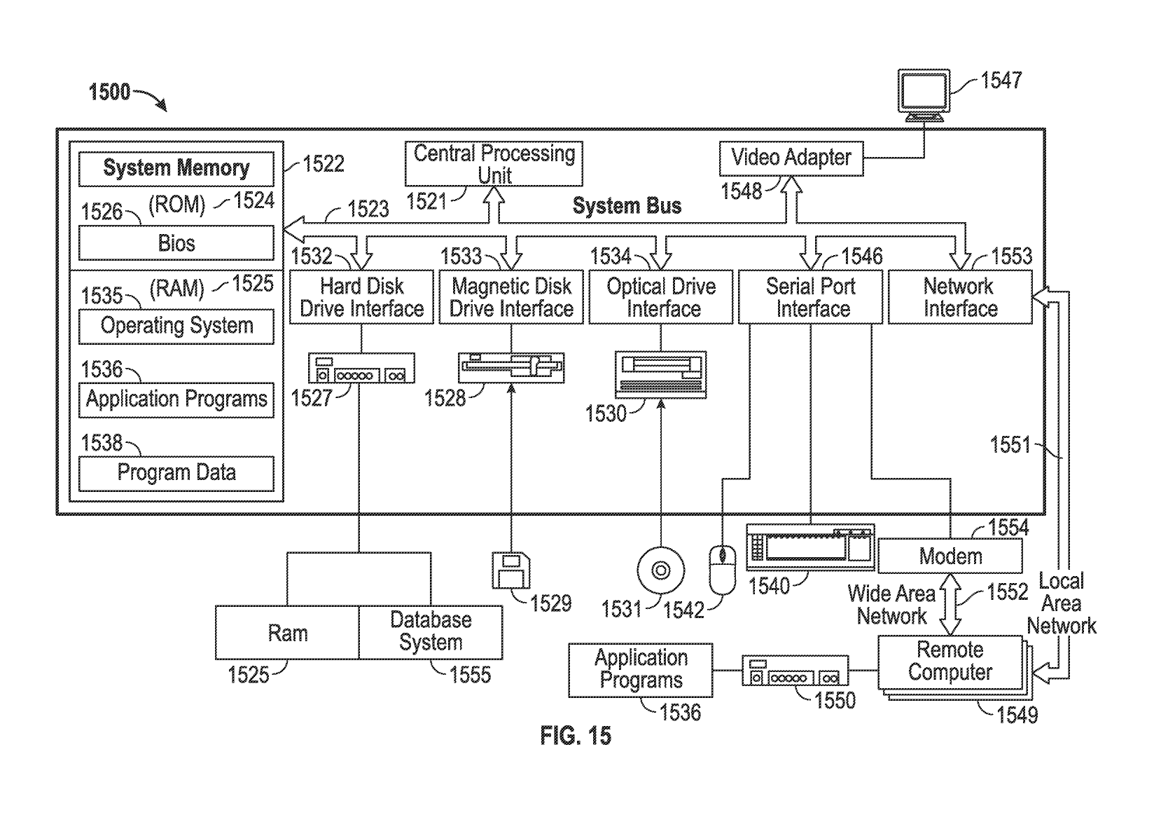

FIG. 15 illustrates a computer system 1500 into which implementations of various technologies and techniques described herein may be implemented. The computer system 1500 may form part of the systems of FIGS. 1A-1D, such as the computer 122.1 and/or surface unit 134. The computer system 1500 may work with the microseismic fracture operation system 150 to perform the functions of the tools thereof, and to perform the methods as described, for example in FIG. 4. One or more computer systems 1500 may be provided on or offsite the oilfield 100.

In one implementation, computing system 1500 may be a conventional desktop or a server computer, but it should be noted that other computer system configurations may be used. The computing system 1500 may include a central processing unit (CPU) 1521, a system memory 1522 and a system bus 1523 that couples various system components including the system memory 1522 to the CPU 1521. Although only one CPU is illustrated in FIG. 15, it should be understood that in some implementations the computing system 1500 may include more than one CPU. The system bus 1523 may be any of several types of bus structures, including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral

A Peripheral Component Interconnect (PCI) bus may also be known as Mezzanine bus. The system memory 1522 may include a read only memory (ROM) 1524 and a random access memory (RAM) 1525. A basic input/output system (BIOS) 1526, containing the basic routines that help transfer information between elements within the computing system 1500, such as during start-up, may be stored in the ROM 1524.

The computing system 1500 may further include a hard disk drive 1527 for reading from and writing to a hard disk, a magnetic disk drive 1528 for reading from and writing to a removable magnetic disk 1529, and an optical disk drive 1530 for reading from and writing to a removable optical disk 1531, such as a CD ROM or other optical media. The hard disk drive 1527, the magnetic disk drive 1528, and the optical disk drive 1530 may be connected to the system bus 1523 by a hard disk drive interface 1532, a magnetic disk drive interface 1533, and an optical drive interface 1534, respectively. The drives and their associated computer-readable media may provide nonvolatile storage of computer-readable instructions, data structures, program modules and other data for the computing system 1500.

Although the computing system 1500 is described herein as having a hard disk, a removable magnetic disk 1529 and a removable optical disk 1531, it should be appreciated by those skilled in the art that the computing system 1500 may also include other types of computer-readable media that may be accessed by a computer. For example, such computer-readable media may include computer storage media and communication media. Computer storage media may include volatile and non-volatile, and removable and non-removable media implemented in any method or technology for storage of information, such as computer-readable instructions, data structures, program modules or other data. Computer storage media may further include RAM, ROM, erasable programmable read-only memory (EPROM), electrically erasable programmable read-only memory (EEPROM), flash memory or other solid state memory technology, CD-ROM, digital versatile disks (DVD), or other optical storage, magnetic cassettes, magnetic tape, magnetic disk storage or other magnetic storage devices, or any other medium which can be used to store the desired information and which can be accessed by the computing system 1500. Communication media may embody computer readable instructions, data structures, program modules or other data in a modulated data signal, such as a carrier wave or other transport mechanism and may include any information delivery media. By way of example, and not limitation, communication media may include wired media such as a wired network or direct-wired connection, and wireless media such as acoustic, RF, infrared and other wireless media. Combinations of any of the above may also be included within the scope of computer readable media.

A number of program modules may be stored on the hard disk 1527, magnetic disk 1529, optical disk 1531, ROM 1524 or RAM 1525, including an operating system 1535, one or more application programs 1536 such as a well analysis program, program data 1538 such as microseismic signal data indicative of shear and compressional waves having amplitudes and frequencies of microseismic events induced by the plurality of well stimulation operations conducted over different time periods, and a database system 1555. The operating system 1535 may be any suitable operating system that may control the operation of a networked personal or server computer, such as Windows® XP, Mac OS® X, Unix-variants (e.g., Linux® and BSD®), and the like. In one implementation, plug-in manager 420, oilfield application 415, the plug-in quality application and the plug-in distribution application described in FIGS. 4-9 in the paragraphs above may be stored as application programs 1536 in FIG. 15.

A user may enter commands and information into the computing system 1500 through input devices such as a keyboard 1540 and pointing device 1542. Other input devices may include a microphone, joystick, game pad, satellite dish, scanner, or the like. These and other input devices may be connected to the CPU 1521 through a serial port interface 1546 coupled to system bus 1523, but may be connected by other interfaces, such as a parallel port, game port or a universal serial bus (USB). A monitor 1547 or other type of display device may also be connected to system bus 1523 via an interface, such as a video adapter 1548. In addition to the monitor 1547, the computing system 1500 may further include other peripheral output devices such as speakers and printers.

Further, the computing system 1500 may operate in a networked environment using logical connections to one or more remote computers 1549. The logical connections may be any connection that is commonplace in offices, enterprise wide computer networks, intranets, and the Internet, such as local area network (LAN) 1551 and a wide area network (WAN) 1552. The remote computers 1549 may each include application programs 1536 similar to that as described above. In one implementation, the plug-in quality application (i.e., performing method 500) stored in plug-in quality center 460 may be stored as application programs 1536 in system memory 1522. Similarly, the plug-in distribution application (i.e., performing method 600) stored in plug-in distribution center 470 may be stored as application programs 1536 in remote computers 1549.

When using a LAN networking environment, the computing system 1500 may be connected to the local network 1551 through a network interface or adapter 1553. When used in a WAN networking environment, the computing system 1500 may include a modem 1554, wireless router or other means for establishing communication over a wide area network 1552, such as the Internet. The modem 1554, which may be internal or external, may be connected to the system bus 1523 via the serial port interface 1546. In a networked environment, program modules depicted relative to the computing system 1500, or portions thereof, may be stored in a remote memory storage device 1550. It will be appreciated that the network connections shown are example and other means of establishing a communications link between the computers may be used. The monitor 1547 may also be implemented remotely and receive video signals from the computing system 1500 via the local area network 1551 or the wide area network 1552 using any suitable protocols, such as TCP/IP and HyperText Markup Language.

It should be understood that the various technologies described herein may be implemented in connection with hardware, software or a combination of both. Thus, various technologies, or certain aspects or portions thereof, may take the form of program code (i.e., computer executable instructions) embodied in tangible media, such as floppy diskettes, CD-ROMs, hard drives, or any other machine-readable storage medium wherein, when the program code is loaded into and executed by a machine, such as a computer, the machine becomes an apparatus for practicing the various technologies. In the case of program code execution on programmable computers, the computing device may include a processor, a storage medium readable by the processor (including volatile and non-volatile memory and/or storage elements), at least one input device, and at least one output device. One or more programs that may implement or utilize the various technologies described herein may use an application programming interface (API), reusable controls, and the like. Such programs may be implemented in a high level procedural or object oriented programming language to communicate with a computer system. However, the program(s) may be implemented in assembly or machine language, if desired. In any case, the language may be a compiled or interpreted language, and combined with hardware implementations.

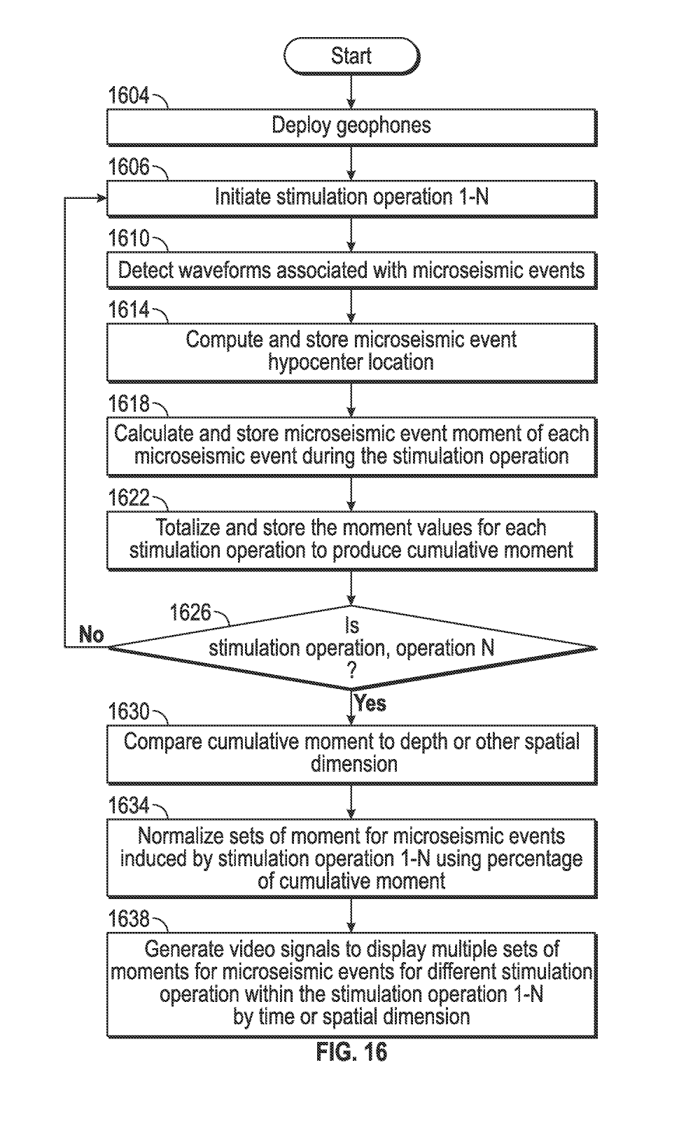

FIG. 16 is a logic flow chart 1600 illustrating a computerized methodology for monitoring at least one performance aspect of a plurality of well stimulation operations conducted on the wellbore 336 penetrating the subterranean formation 306. A variety of types of performance aspects can be monitored, such as a percentage of microseismic events occurring within the reservoir 304, differences and similarities in the microseismic events induced by separate well stimulation operations for the same or different wellbores 336, dimensions of the microseismic event cloud and volumetric calculations of the volume of rock containing microseismic events. Dimensions (height, length, width, azimuth) and volumes can be computed and displayed as a function of time.

As shown in step 1604, to monitor the at least one performance aspect, a plurality of data acquisition tools 202.4, for example, including geophones 118 or geophones S, are positioned proximate to the subterranean formation 306 so as to be able to receive microseismic signals indicative of microseismic events induced by the well stimulation operations. The data acquisition tools 202.4 can include geophones positioned on the surface, within a shallow bore, within a monitoring well and combinations thereof. In the example discussed above and shown in FIG. 4, twelve data acquisition tools 202.4 are deployed. However, it should be understood that more or less of the data acquisition tools 202.4 can be deployed to monitor a wellsite stimulation operation.

Once the data acquisition tools 202.4 are deployed, a well stimulation operation is initiated and conducted as shown in step 1606. As discussed above, the well stimulation operation can be a hydraulic fracturing operation or an acidizing operation. One skilled in the art will understand that the performance of a well stimulation operation includes deploying a variety of specialized equipment and materials at the wellsite 302 as well as directing a fluid containing predetermined materials into the wellbore 336 under predetermined conditions.

During the well stimulation operation, microseismic signals including shear and compressional waves are detected by the plurality of data acquisition tools 202.4 at a step 1610. As discussed above, and shown in FIG. 4, the shear and compressional waves have amplitudes and frequencies indicative of microseismic events induced by the well stimulation operation over a time period.

Microseismic data indicative of the microseismic signals is then transmitted to and received by at least one processor, e.g., the central processing unit 1521 of the computer system 1500. The microseismic data can be transmitted in an analog or digital format. When the microseismic data is transmitted in the analog format, a conversion unit, such as an analog to digital converter can be used to convert the microseismic data into a digital format such that the microseismic data can be analyzed by the central processing unit 1521. As shown in step 1614, the central processing unit 1521 computes and stores on a computer readable media, such as the hard disk drive 1527, a hypocenter location for each microseismic event based upon the relative timing of the shear and compressional waves received by the plurality of data acquisition tools. At a step 1618, the central processing unit 1521 also calculates seismic moments of each detected and located microseismic event, and based upon the shear and compressional waves received by the plurality of data acquisition tools 202.4 using any suitable formula, such as Equation (6) set forth above. At a step 1622, the central processing unit 1521 then totalizes (e.g., sums) the seismic moment values to a form a cumulative moment of the microseismic events occurring during the time period.

At a step 1626 the central processing unit 1521 then determines if all of the well stimulation operations 1-N have been completed, and if not the central processing unit 1521 branches to the step 1606 to wait for the initiation of another well stimulation operation. Once all of the well stimulation operations 1-N have been completed, at a step 1630, the cumulative moment can be compared to depth or other spatial dimension to provide a qualitative evaluation of microseismic responses observed during multiple well stimulation operations conducted within a single wellbore or group of wellbores located within the same geographic horizon. This evaluation can be of observed deformations within rock strata induced by the well stimulation operation. At a step 1634, the central processing unit 1521 may also normalize the seismic moments for each well stimulation operation with the cumulative moment for each well stimulation operation to transform the seismic moments into normalized seismic moment data sets. The central processing unit 1521 stores the seismic moments, the cumulative moments and the normalized seismic moment data sets on the computer readable media, such as the hard disk drive 1527.

Thereafter, at a step 1638, the central processing unit 1521 and/or the video adapter 1548 generate video signals to display multiple sets of moments for microseismic events for different well stimulation operations by time or spatial dimension. The video signals can be generated in any suitable format. For example, the video signals can include analog components for red, green, blue, horizontal sync and vertical sync, or digital components such as compressed or uncompressed video data. The video signals can also be generated in a networked environment in which the central processing unit 1521 provides instructions to one or more of the remote computers 1549 using any suitable protocol, such as hypertext markup language to cause the remote computer 1549 to render the video signals with a rendering program and then display the video signals.

While the foregoing is directed to implementations of various technologies described herein, other and further implementations may be devised without departing from the basic scope thereof, which may be determined by the claims that follow. Although the subject matter has been described in language specific to structural features and/or methodological acts, it is to be understood that the subject matter defined in the appended claims may not be limited to the specific features or acts described above. Rather, the specific features and acts described above are disclosed as example forms of implementing the claims.

Although only a few example embodiments have been described in detail above, those skilled in the art will readily appreciate that many modifications are possible in the example embodiments without materially departing from this invention. Accordingly, such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. §112, paragraph 6 for any limitations of any of the claims herein, except for those in which the claim expressly uses the words ‘means for’ together with an associated function.

What is claimed is:

1. A method of performing a well stimulation operation for a wellsite having a subterranean formation, comprising:
positioning a plurality of data acquisition tools proximate to the subterranean formation;
conducting a well stimulation operation on a production well penetrating the subterranean formation;
detecting microseismic signals including shear and compressional waves by the plurality of data acquisition tools, the shear and compressional waves having amplitudes and frequencies indicative of microseismic events induced by the well stimulation operation over a time period from T1 to T2;
calculating, by a processor, seismic moments of the microseismic events based upon the shear and compressional waves received by the plurality of data acquisition tools;
totalizing, by the processor, the seismic moment values to a form a cumulative moment of the microseismic events occurring during the time period; and
normalizing, by the processor, the seismic moments with the cumulative moment to transform the seismic moments into a normalized seismic moment data set.

2. The method of claim 1, further comprising generating video signals indicative of the normalized seismic moment data set and transmitting the video signals to a display unit.

3. The method of claim 2, further comprising the step of calculating and storing a time value of the microseismic event, and wherein the video signals are indicative of a graph having a first axis of representing time and a second axis representing values of the normalized seismic moment data set.

4. The method of claim 2, further comprising the step of calculating and storing a hypocenter location of the microseismic events, and wherein the video signals are indicative of a graph having a first axis representing at least one spatial dimension of the hypocenter locations, and a second axis representing values of the normalized seismic moment data set.

5. The method of claim 4, wherein the at least one spatial dimension is depth.

6. The method of claim 5, wherein the subterranean formation is an oil or gas reservoir, and wherein the video signals also include indicia representing top and bottom depths of the oil or gas reservoir.

7. A method of monitoring at least one performance aspect of a plurality of well stimulation operations conducted on a production well penetrating a subterranean formation, comprising:
a. detecting microseismic signals including shear and compressional waves by a plurality of data acquisition tools positioned proximate to the production well, the shear and compressional waves having amplitudes and frequencies indicative of microseismic events induced by the plurality of well stimulation operations over different time periods;
for each well stimulation operation:
b. calculating, by a processor, seismic moments of the microseismic events based upon the shear and compressional waves received by the plurality of data acquisition tools;
c. totalizing, by the processor, the seismic moment values to a form a cumulative moment of the microseismic events occurring during the time period; and
d. normalizing, by the processor, the seismic moments with the cumulative moment to transform the seismic moments into a normalized seismic moment data set.

8. The method of claim 7, further comprising generating video signals indicative of at least two of the normalized seismic moment data sets and transmitting the video signals to a display unit.

9. The method of claim 8, further comprising the step of calculating and storing a time value of the microseismic event, and wherein the video signals are indicative of a graph having a first axis of representing time and a second axis representing values of the at least two normalized seismic moment data sets.

10. The method of claim 8, further comprising the step of calculating and storing a hypocenter location of the microseismic events, and wherein the video signals are indicative of a graph having a first axis representing at least one spatial dimension of the hypocenter locations, and a second axis representing values of the at least two normalized seismic moment data sets.

11. The method of claim 10, wherein the at least one spatial dimension is depth.

12. The method of claim 11, wherein the subterranean formation is an oil or gas reservoir, and wherein the video signals also include indicia representing top and bottom depths of the oil or gas reservoir.

13. A computer system for monitoring at least one performance aspect of a plurality of well stimulation operations conducted on a production well penetrating a subterranean formation, comprising:
at least one processor; and
at least one computer readable medium coupled to the at least one processor, the at least one computer readable medium storing microseismic signal data indicative of shear and compressional waves having amplitudes and frequencies of microseismic events induced by the plurality of well stimulation operations conducted over different time periods, and a well analysis program including computer executable instructions executed by the at least one processor for each well stimulation operation to:
calculate seismic moments of the microseismic events based upon the shear and compressional waves of the microseismic signal data;
totalize the seismic moment values to a form a cumulative moment of the microseismic events; and
normalize the seismic moments with the cumulative moment of the microseismic events to transform the seismic moments into a normalized seismic moment data set.

14. The computer system of claim 13, wherein the well analysis program further comprises computer executable instructions executed by the at least one processor to generate video signals indicative of at least two of the normalized seismic moment data sets and transmit the video signals to a display unit.

15. The computer system of claim 14, wherein the well analysis program further comprises computer executable instructions executed by the at least one processor to calculate and store a time value of the microseismic event, and wherein the video signals are indicative of a graph having a first axis of representing time and a second axis representing values of the at least two normalized seismic moment data sets.

16. The computer system of claim 14, wherein the well analysis program further comprises computer executable instructions executed by the at least one processor to calculate and storing a hypocenter location of the microseismic events, and wherein the video signals are indicative of a graph having a first axis representing at least one spatial dimension of the hypocenter locations, and a second axis representing values of the at least two normalized seismic moment data sets.

17. The computer system of claim 16, wherein the at least one spatial dimension is depth.

18. The computer system of claim 17, wherein the subterranean formation is an oil or gas reservoir, and wherein the video signals also include indicia representing top and bottom depths of the oil or gas reservoir.
